(19) United States
(12) Patent Application Publication
(10) Pub. No.: US 2006/0110580 A1
(43) Pub. Date: May 25, 2006

(54) Article comprising conductive conduit channels

(76) Inventors: Peter T. Aylward, Hilton, NY (US); Cheryl J. Kaminsky, Greer, SC (US); Robert P. Bourdelais, Pittsford, NY (US); Fitzroy H. Crosdale, Rochester, NY (US); Debasis Majumdar, Rochester, NY (US); Daniel A. Slater, Rochester, NY (US)

Correspondence Address: Paul A. Leipold;Patent Legal Staff, Eastman Kodak Company, 343 State Street, Rochester, NY, 14650-2201, US

(21) Appl. No.: 11/260,615

(22) Filed: Oct. 27, 2005

Related U.S. Application Data
(63) Continuation-in-part of application No. 10/425,005, filed on Apr. 28, 2003.

(51) Int. Cl. B32B 3/00

(52) U.S. Cl. 428/172

(57) ABSTRACT

An electromodulating display comprises (1) a nonconductive polymeric unitary substrate containing a plurality of patterned grooves containing an electrically-conductive material so as to form an electrical network having a switchable electric field orientation; (2) a switch for switching the electric field orientation; and (3) a medium that is optically shifted in response to the switching of the electric field orientation.

### CROSS REFERENCE TO RELATED APPLICATIONS

This application is a continuation-in-part of U.S. Ser. No. 10/425,005 filed Apr. 28, 2003, the contents of which are incorporated herein by reference. Inventions on related subject matter are disclosed in U.S. Ser. Nos. 10/424,666; 10/424,639; and 10/425,012, all filed on Apr. 28, 2003.

### FIELD OF THE INVENTION

The invention relates to an article comprising a patterned conductive sheet aligned to form conduits in the plane of the conductive sheet.

### BACKGROUND OF THE INVENTION

As electronic devices become smaller, the requirements for precise electrical connection at extremely fine pitch continue to increase. As an example, semiconductors, such as integrated circuits, are formed on silicon wafers that are then cut into dice or chips that individually may be mounted on substrates. Typically, the substrate has fine electrically conductive circuit lines, and electrical and thermal contact must be made between the substrate and chip. As electronic appliances, such as computers, tape players, televisions, telephones, and other appliances become smaller, thinner, and more portable, the size requirements for semiconductors and the electrical connections between semiconductors and substrates, or between flexible circuits and rigid printed circuits, become increasingly demanding.

One method for providing electrical conductivity between two electrical elements is through the use of a Z-axis conductive sheet material, such as a Z-axis adhesive. Whether the sheet material is elastomeric or adhesive, the continuing challenge is to keep pace with the miniaturization in the electronics industry. Z-axis conductivity can be achieved through a number of means, including dispersing conductive particles throughout a binder matrix. Where electrical connection on a very fine pitch is required, the conductive elements may be placed only where the electrodes are located, typically requiring indexing the conductive sheet to the electrodes, or the conductive elements may be placed at such close spacing, relative to the spacing of the electrodes, that indexing is not required. U.S. Pat. No. 5,087,494, (Calhoun et al.) is an example of an electrically conductive adhesive tape having conductive particles placed at precise locations, on a fine pitch. The Calhoun et al. '494 patent also discusses a number of available options for electrically conductive adhesive tapes.

U.S. Pat. Nos. 4,008,300 (Ponn) and 3,680,037 (Nellis, et al.) teach a dielectric sheet material having a plurality of compressible resilient conductive plugs that extend between the faces of the sheet. The sheet can be placed between circuits to make electrical connection there between. The conductive plugs of Ponn and Nellis are dispersions of conductive particles in a binder material.

Other patents teach orienting magnetic particles dispersed in a binder by applying a magnetic field, e.g., U.S. Pat. Nos. 4,448,837 (Ikade, et al.); 4,546,037 (King); 4,548,862 (Hartman); 4,644,101 (Jin, et al.); and 4,838,347 (Dentinni). The distribution of the particles after orientation and curing is sufficiently uniform to be functional for certain applications, but is insufficient for other applications. If the number of particles used in these articles were to be increased in an attempt to reach smaller spacings for finer pitch connections, agglomeration would likely occur thereby causing shorting. Accordingly, there is a need for fine pitch electrical interconnections between two surfaces in a precise manner.

U.S. Pat. No. 5,522,962 teaches conductive sheets that are conductive through the thickness but insulating in the lateral directions. While conductive materials are disclosed, they tend to have low light transmission and therefore are not particularly useful in transmission devices such as liquid crystal displays. Further, the conductive materials utilized in this patent are conductive ferromagnetic particles coated in a binder.

The formation of patterned surfaces can be accomplished in a variety of well-known manners. One known prior process for preparing chill rollers involves creating a main surface pattern using a mechanical engraving process. The engraving process has many limitations including misalignment causing tool lines in the surface, high price, and lengthy processing. Accordingly, it is desirable to not use mechanical engraving to manufacture chill rollers.

U.S. Pat. No. 6,285,001 (Fleming et al) relates to an exposure process using excimer laser ablation of substrates to improve the uniformity of repeating microstructures on an ablated substrate or to create three-dimensional microstructures on an ablated substrate. This method is difficult to apply to create a master chill roll useful to manufacture complex random three-dimensional structures and is also cost prohibitive.

Conductive layers containing electronic conductors such as conjugated conducting polymers, conducting carbon particles, crystalline semiconductor particles, amorphous semiconductive fibrils, and continuous semiconducting thin films can be used more effectively than ionic conductors to dissipate static charge since their electrical conductivity is independent of relative humidity and only slightly influenced by ambient temperature. Of the various types of electronic conductors, electrically conducting metal-containing particles, such as semiconducting metal oxides, are particularly effective when dispersed in suitable polymeric film-forming binders in combination with polymeric non-film-forming particles as described in U.S. Pat. Nos. 5,340,676; 5,466,567; 5,700,623. Binary metal oxides doped with appropriate donor heteroatoms or containing oxygen deficiencies have been disclosed in prior art to be useful in antistatic layers for photographic elements, for example, U.S. Pat. Nos. 4,275,103; 4,416,963; 4,495,276; 4,394,441; 4,418,141; 4,431,764; 4,495,276; 4,571,361; 4,999,276; 5,122,445; 5,294,525; 5,382,494; 5,459,021; 5,484,694 and others. Suitable claimed conductive metal oxides include: zinc oxide, titania, tin oxide, alumina, indium oxide, silica, magnesia, zirconia, barium oxide, molybdenum trioxide, tungsten trioxide, and vanadium pentoxide. Preferred doped conductive metal oxide granular particles include antimony-doped tin oxide, fluorine-doped tin oxide, aluminum-doped zinc oxide, and niobium-doped titania. Additional preferred conductive ternary metal oxides disclosed in U.S. Pat. No. 5,368,995 include zinc antimonate and indium antimonate. Other conductive metal-containing granular particles including metal borides, carbides, nitrides and suicides have been disclosed in Japanese Kokai No. JP 04-055,492.

U.S. Pat. Nos. 6,077,655; 6,096,491; 6,124,083; 6,162,596; 6,187,522; 6,190,846; and others describe imaging elements, including motion imaging films, containing electrically conductive layers comprising conductive polymers. One such electrically-conductive polymer comprises an electrically conductive 3,4-dialkoxy substituted polythiophene styrene sulfonate complex.

In U.S. Pat. Nos. 6,822,783 and 6,639,580 and US Pat. application 20030011869A1, an electrophoretic display with an inner space between two separate opposed substrates is shown. A stage is formed in a layer on the substrate. The staged areas typically are applied and then selectively removed to form an area of different thickness. Electrodes and other dielectric layers are on the surface of the substrate. Processing steps to apply and then remove parts of the stage layer leave the electrode structures prone to damage from handling and conveyance. Additionally the structures described are difficult to make because they are coated and then patterned to form regions of different heights. Subtractive removing of material is always more costly and difficult to control particularly when the feature size being made is in the micron range. Furthermore the opposing substrates need to be properly aligned to provide the electrical fields to move the particles to their intended positions. Overall this is a very complicated process and design and there remains a need to protect the electrodes and dielectric layer from damage while providing a process that is more simple and less costly.

### PROBLEM TO BE SOLVED BY THE INVENTION

There remains a need for an electrically conductive article that is transparent or opaque for use in display devices while being protected from abrasion or harsh ambient conditions.

### SUMMARY OF THE INVENTION

The invention provides an electromodulating display comprising

(1) a nonconductive polymeric unitary substrate containing a plurality of patterned grooves containing an electrically-conductive material so as to form an electrical network having a switchable electric field orientation and

(2) a switch for switching the electric field orientation; and

(3) a medium that is optically shifted in response to the switching of the electric field orientation. The invention also includes processes for making the article, an electromodulating display, and a thin film transistor (TFT).

### ADVANTAGEOUS EFFECT OF THE INVENTION

The invention provides readily manufactured article exhibiting improved light transmission while simultaneously providing conductive conduits. The invention also provides protection for the delicate conductive coatings from abrasion or harsh ambient conditions such as those typical of display devices. When used to make displays and TFT's, this invention serves to reduce the height or Z-directional thickness of the display. In areas where there are electrical crossovers of two or more electrically conductive features as well as a way of providing electrical isolation to prevent shorting between the electrical conducting features, the thickness of these layers and any transition areas approaching or leaving the crossover region use a large amount of area and that can interfere with the viewing of the display pixels. Typically conductive lines used for flexible displays are very thin and brittle and are prone to breakage when flexed or are subjected to abrasion that can break the electrical continuity of the conductive line and render the article or parts of it useless. By providing conductive lines that are below the surface of the polymer sheet (substrate), many of these problems can be overcome because they are not in direct contact with the physical environment at the surface such as a viewer touching or otherwise handling the display. Furthermore if multiple layers of conductive material and dielectrics are placed in a trench, the surface is free of conductive lines and may be processed in a roll-to-roll manufacture process without fear of damaging the display. Also by burying the conductive lines, crossover regions can be made without added height to the display plane that otherwise will result in optical viewing problems. By placing the electrically conductive electrodes closer to the central axis of the flexible, any bending in either compression or expansion will be more uniform and therefore provide for a more robust display.

### BRIEF DESCRIPTION OF THE DRAWINGS

FIG. 1A is an illustrative schematic top view of a display pixel showing a number of electrodes.

FIG. 1B is a schematic top view of a small array of pixel with a electrodes for providing a shift in the electrical field orientation.

FIG. 2A is a schematic top view of an electrical cross-over.

FIG. 2B is a schematic cross sectional view on a polymer sheet with trenched electrodes and dielectric that form a cross-over.

FIG. 2C is a schematic three dimensional view of an electrical crossover with dielectric at the point of cross-over.

FIG. 3 is a schematic crossover with one electrode and dielectric in a trench and a second electrode on the polymer sheet surface.

FIG. 4 is a schematic cross sectional view of a polymer sheet with varying trench depths and shapes.

FIG. 5 is a schematic cross sectional view of a trenched polymer sheet with walls containing an electromodulating fluid.

FIG. 6 is a schematic top view of an electromodulating display with more than one display pixel that start to form the rows and columns. It provides a view of the complexity of the large number of potential cross-overs.

FIG. 7 is a schematic three dimensional cross sectional view of an electrical crossover in which only the region of the cross-over is trenched.

FIG. 8 A is a schematic of electrowetting cells with fluid containing walls and with two non-miscible fluids in the cell. FIG. 8 B is a schematic of electrowetting cells with fluid containing walls and with two non-miscible fluids in the cell and a voltage applied to move one of the liquids.

FIG. 9 illustrates a schematic cross section of conductive conduit containing a conductive material and a electrical protection layer and a second conductor in accordance with the invention.

### DETAILED DESCRIPTION OF THE INVENTION

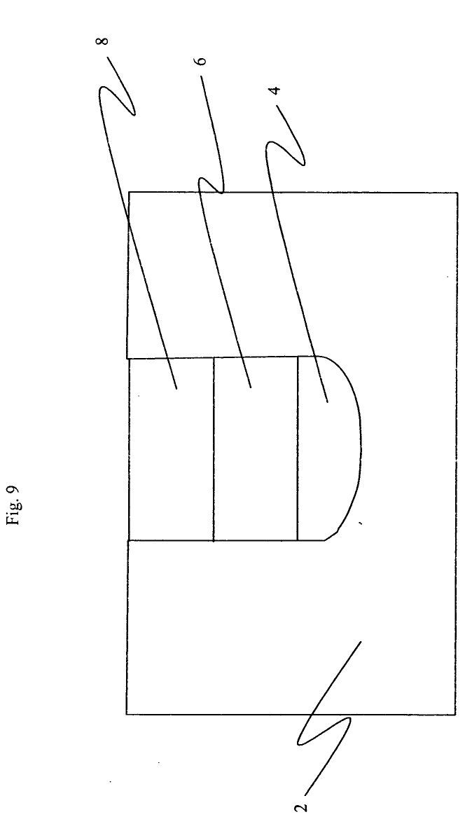

The FIG. 9 illustrates a cross section of a sheet 2 with a conductive conduit containing a conductive material and an electrical protection layer and a second conductor. Polymer base sheet 2 contains a conduit. Conductive polymer 4 is applied to the bottom of the conduit. Electrical protective material 6 is applied on top of conductive polymer 4 to electrically isolate it from second conductor 8. A groove, trench, channel or conduit as defined is a open trench that can be filled or partly filled with a different material other than the polymer sheet material. Even when filled in a cross sectional view the groove is only on three side of the filled material.

The invention has numerous advantages over prior practices in the art. The invention provides an electrically conductive sheet material that is conductive in the plane of the sheet while being transparent or opaque to light energy perpendicular to the direction of the sheet. The unitary substrate is defined as having a single support/sidewall structure that forms a groove, trench or conduit as opposed to bearing a separate sidewall layer. Such substrates have a preformed network of trenches that are an integral part of the substrate as opposed to being formed by coating or patterning a layer(s) that is applied to, transferred or laminated to the surface of the substrate. Conductive conduits, which are spaced by insulating thermoplastic in lateral directions, provide precision pathways for conducting of electricity from an origination point to the destination. Conducting sheets that are patterned and are transparent or opquae to visible light can be used for membrane switches, radio frequency antennae, display devices, connections between semiconductors and substrates or between flexible circuits and rigid printed circuits. When the conductive material is transparent, the article or sheet of the invention may also be utilized in combination with imaging layers such as ink jet printed images. The trenched polymer sheet may be transparent, translucent or opaque. Transparent sheets are useful for stacked display that may contain one or more trenched polymer sheets. Opaque sheets are useful for reflective display to maximize the reflectance of the bottom layer. The sheet may be spectrally or diffusively reflective. The preferred bottom sheet is white with a reflectance of >85% and the most preferred has a diffuse reflectance of between 94 and 100%.

Other fillers useful in this invention may also include conductors such as but not limited to fillers, conductors (polythiphene, Ag, Au, Al, Cu, Ni, Zn), dielectrics, semi-conductors, electromodulating medium, precursor for growing metals such as a palladium catalysts that is deposited into the trench and then a metal grown inside the trench using an electrolysis plating process.

The conduit channels are located below the grade or upper surface of the polymer unitary substrate (suitably thermoplastic and non-conductive) and can be formed in a variety of sizes and shapes to provide the desired input and output characteristics. Because the conduits are polymeric, the conduits can also have a variety of orientations such as conduits that are perpendicular to each other, conduits which curve, circular conduits or conduits that are connected at some logical point. Furthermore when the conduit channels are filled with a conductive material such as a polymeric conductor and or dielectric, the resulting article of this invention may be bent. When the filling material in the conduit channel is metallic in nature it may demonstrate enhanced bending properties since it is supported on three sides by the trenched polymer sheet as opposed to a conductive surface feature that is only support on one side. By partly filling the trench with an elastic material that has a modulus of elasticity that is between the modulus of elasticity of the polymer sheet and that on the conductive material, improved cracking performance is achieved.

The conductive conduits in the invention provide protection to the electrically conductive material contained in the conduits. By protecting the conductive material of the invention, scratching, abrasion, and contamination of the electrically conductive material are greatly reduced compared to prior art conductive patterns that reside of the surface of a substrate. Scratching of the conductive material could result in an unwanted disruption of in the conductivity of one or more conduits resulting in device failure. Because the conductive material of the invention is contained with conduits, the coating is further protected with an auxiliary coating, creating a coating surface for cholesteric liquid crystals for example.

The conductive conduits in the invention may form regions or areas in which the conductive trenches form a crossover. A crossover is when at least two conductive features (electrodes) intersect but at a different Z-dimension plane. Each electrode is supplying power to a different part of the display that needs to function independently of the other and therefore electrical isolation needs to be provided between the two electrodes. The advantage of provide these crossovers below the surface of the display is that they are visually less objectionable and take up less space than a crossover that occurs on the surface. Surface crossovers require a transition area in which one of the electrodes is gradually elevated in height in order to span the bottom electrode and the dielectric layer. For displays with electromodulating material that are sealed in a cell that is only a few microns in depth, surface crossover may interfere with the sealing of the cells. When the crossovers are all or partly below the surface, they do not interfere with the sealing aspect of these displays.

The term micro-cell refers to a well or depression in or on top of the in the polymer sheet that confines a fluid within in boundaries. From a top view perspective a continuous wall would surround the cell on four side in an x,y dimension, the polymer sheet would form the floor or bottom of the microcell. The cell is filled with an electromodulating material (usually a liquid or liquid dispersion. And then a top-sealing layer is applied to the top of the mirco-cell so as to encapsulate the electromodulating material.

Electromodulating

In one embodiment, at least one imageable layer is applied to a nonconductive polymeric unitary substrate comprising a plurality of patterned integral conduit channels containing a conductive material. The imageable layer preferably contains an electrically imageable material. The electrically imageable material can be light emitting or light modulating. Light emitting materials can be inorganic or organic in nature. Particularly preferred are organic light emitting diodes (OLED) or polymeric light emitting diodes (PLED). The light modulating material can be reflective or transmissive. Light modulating materials can be electrochemical, electrophoretic, such as Gyricon particles, electrochromic, electrowetting or liquid crystals. The liquid crystalline material can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Structures having stacked imaging layers or multiple support layers, however, are optional for providing additional advantages in some case.

In a preferred embodiment, the electrically imageable material can be addressed with an electric field and then retain its image after the electric field is removed, a property typically referred to as “bistable”. Particularly suitable electrically imageable materials that exhibit “bistability” are electrochemical, electrophoretic, such as Gyricon particles, electrochromic, magnetic, or chiral nematic liquid crystals. Especially preferred are chiral nematic liquid crystals. The chiral nematic liquid crystals can be polymer dispersed liquid crystals (PDLC). Bistable display technology is one of the newest technologies to become commercially available. There are a number of different approaches, but they all share the ability to retain an image or position in the case of electrophoretic and electrowetting even when the power to the display has been turned off. This makes them especially useful for portable, battery-powered devices where the information on the display changes relatively infrequently. E Ink uses microscopic electrophoretic particles encapsulated in tiny spheres. These particles respond to the application of a charge across a cell: Negatively charged black particles or positively charged white ones are drawn to the viewing surface, depending on the charge between the electrodes. They stay in position when the charge is eliminated, resulting in a display that retains its image with the power turned off.

The electrically modulated material may also be a printable, conductive ink having an arrangement of particles or microscopic containers or microcapsules. Each microcapsule contains an electrophoretic composition of a fluid, such as a dielectric or emulsion fluid, and a suspension of colored or charged particles or colloidal material. The diameter of the microcapsules typically ranges from about 30 to about 300 microns. According to one practice, the particles visually contrast with the dielectric fluid. According to another example, the electrically modulated material may include rotatable balls that can rotate to expose a different colored surface area, and which can migrate between a forward viewing position and/or a rear non-viewing position, such as gyricon. Specifically, gyricon is a material comprised of twisting rotating elements contained in liquid filled spherical cavities and embedded in an elastomer medium. The rotating elements may be made to exhibit changes in optical properties by the imposition of an external electric field. Upon application of an electric field of a given polarity, one segment of a rotating element rotates toward, and is visible by an observer of the display. Application of an electric field of opposite polarity, causes the element to rotate and expose a second, different segment to the observer. A gyricon display maintains a given configuration until an electric field is actively applied to the display assembly. Gyricon particles typically have a diameter of about 100 microns. Gyricon materials are disclosed in U.S. Pat. No. 6,147,791, U.S. Pat. No. 4,126,854 and U.S. Pat. No. 6,055,091,

According to one practice, the microcapsules may be filled with electrically charged white particles in a black or colored dye. Examples of electrically modulated material and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898.

The electrically modulated material may also include material disclosed in U.S. Pat. No. 6,025,896. This material comprises charged particles in a liquid dispersion medium encapsulated in a large number of microcapsules. The charged particles can have different types of color and charge polarity. For example white positively charged particles can be employed along with black negatively charged particles. The described microcapsules are disposed between a pair of electrodes, such that a desired image is formed and displayed by the material by varying the dispersion state of the charged particles. The dispersion state of the charged particles is varied through a controlled electric field applied to the electrically modulated material. According to a preferred embodiment, the particle diameters of the microcapsules are between about 5 microns and about 200 microns, and the particle diameters of the charged particles are between about one-thousandth and one-fifth the size of the particle diameters of the microcapsules.

Further, the electrically modulated material may include a thermochromic material. A thermochromic material is capable of changing its state alternately between transparent and opaque upon the application of heat. In this manner, a thermochromic imaging material develops images through the application of heat at specific pixel locations in order to form an image. The thermochromic imaging material retains a particular image until heat is again applied to the material. Since the rewritable material is transparent, UV fluorescent printings, designs and patterns underneath can be seen through.

The electrically modulated material may also include surface stabilized ferroelectric liquid crystals (SSFLC). Surface stabilized ferroelectric liquid crystals confining ferroelectric liquid crystal material between closely spaced glass plates to suppress the natural helix configuration of the crystals. The cells switch rapidly between two optically distinct, stable states simply by alternating the sign of an applied electric field.

Magnetic particles suspended in an emulsion comprise an additional imaging material suitable for use with the present invention. Application of a magnetic force alters pixels formed with the magnetic particles in order to create, update or change human and/or machine readable indicia. Those skilled in the art will recognize that a variety of bistable nonvolatile imaging materials are available and may be implemented in the present invention.

The electrically modulated material may also be configured as a single color, such as black, white or clear, and may be fluorescent, iridescent, bioluminescent, incandescent, ultraviolet, infrared, or may include a wavelength specific radiation absorbing or emitting material. There may be multiple layers of electrically modulated material. Different layers or regions of the electrically modulated material display material may have different properties or colors. Moreover, the characteristics of the various layers may be different from each other. For example, one layer can be used to view or display information in the visible light range, while a second layer responds to or emits ultraviolet light. The nonvisible layers may alternatively be constructed of non-electrically modulated material based materials that have the previously listed radiation absorbing or emitting characteristics. The electrically modulated material employed in connection with the present invention preferably has the characteristic that it does not require power to maintain display of indicia.

In another embodiment is a nonconductive polymeric unitary substrate comprising a plurality of patterned integral conduit channels containing a conductive material bearing a conventional polymer dispersed light modulating material. The liquid crystal (LC) is used as an optical switch. The supports may be manufactured with transparent or opaque, conductive electrodes, in which electrical “driving” signals are coupled. The driving signals induce an electric field which can cause a phase change or state change in the LC material, the LC exhibiting different light reflecting characteristics according to its phase and/or state

In a preferred embodiment of this invention the electromodulating display may comprise an electrowetting material. Electrowetting is typically a reflective display. Electrowetting forms the base for a novel technology for reflective, paper-like displays. The technology is fast enough to display video content and can be used to build a reflective full-color display that is at least two times brighter than current LCD or OLED technologies. The display is based on control and manipulation of fluid motion on a micrometer scale. An optical stack, comprising a non-conducting polymeric white (reflecting) substrate comprising a plurality of patterned integral conduit channels containing a transparent conductive material with, a hydrophobic insulator, a colored oil layer and water. In equilibrium the colored oil naturally forms a continuous film between the water and the hydrophobic insulator. Due to the dominance of interfacial over gravitational forces in small systems (<2 mm) the oil film is stable in all orientations. However, when a voltage difference is applied across the hydrophobic insulator, an electrostatic term is added to the energy balance and the stacked state is no longer energetically favorable. The system can lower its energy by moving the water into contact with the insulator, thereby displacing the oil (Fig. b) and exposing the underlying white surface. The balance between electrostatic and capillary forces determines how far the oil is moved to the side. In this way the optical properties of the stack when viewed from above can be tuned between a colored off-state and a white on-state, provided the pixel is sufficiently small so that the eye averages the optical response. By contracting a colored oil film electrically, an optical switch with a high reflectivity (>40%) and contrast ratio (>15) is obtained. In addition to the attractive optical properties, the principle shows a video-rate response speed (<10 ms) and has a clear route toward a high-brightness color display.

Other display technologies may LCDs organic or polymer light emitting devices (OLEDs) or (PLEDs), which are comprised of several layers in which one of the layers is comprised of an organic material that can be made to electroluminesce by applying a voltage across the device. An OLED device is typically a laminate formed in a substrate such as glass or a plastic polymer. A light emitting layer of a luminescent organic solid, as well as adjacent semiconductor layers, are sandwiched between an anode and a cathode. The semiconductor layers can be hole injecting and electron injecting layers. PLEDs can be considered a subspecies of OLEDs in which the luminescent organic material is a polymer. The light emitting layers may be selected from any of a multitude of light emitting organic solids, e.g., polymers that are suitably fluorescent or chemiluminescent organic compounds. Such compounds and polymers include metal ion salts of 8-hydroxyquinolate, trivalent metal quinolate complexes, trivalent metal bridged quinolate complexes, Schiff-based divalent metal complexes, tin (IV) metal complexes, metal acetylacetonate complexes, metal bidenate ligand complexes incorporating organic ligands, such as 2-picolylketones, 2-quinaldylketones, or 2-(o-phenoxy) pyridine ketones, bisphosphonates, divalent metal maleonitriledithiolate complexes, molecular charge transfer complexes, rare earth mixed chelates, (5-hydroxy) quinoxaline metal complexes, aluminum tris-quinolates, and polymers such as poly(p-phenylenevinylene), poly(dialkoxyphenylenevinylene), poly(thiophene), poly(fluorene), poly(phenylene), poly(phenylacetylene), poly(aniline), poly(3-alkylthiophene), poly(3-octylthiophene), and poly(N-vinylcarbazole). When a potential difference is applied across the cathode and anode, electrons from the electron injecting layer and holes from the hole injecting layer are injected into the light emitting layer; they recombine, emitting light. OLEDs and PLEDs are described in the following United States patents: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

In a typical matrix address light emitting display device, numerous light emitting devices are formed on a single substrate and arranged in groups in a regular grid pattern. Activation may be by rows and columns, or in an active matrix with individual cathode and anode paths. OLEDs are often manufactured by first depositing a transparent electrode on the substrate, and patterning the same into electrode portions. The organic layer(s) is then deposited over the transparent electrode. A metallic electrode can be formed over the electrode layers. For example, in U.S. Pat. No. 5,703,436 to Forrest et al, transparent indium tin oxide (ITO) is used as the hole injecting electrode, and a Mg—Ag—ITO electrode layer is used for electron injection.

Functional Layers (Mini)

The above described may also comprises at least one “functional layer” between the conductive layer and the substrate. The functional layer may comprise a protective layer or a barrier layer. The protective layer useful in the practice of the invention can be applied in any of a number of well known techniques, such as dip coating, rod coating, blade coating, air knife coating, gravure coating and reverse roll coating, extrusion coating, slide coating, curtain coating, and the like. The liquid crystal particles and the binder are preferably mixed together in a liquid medium to form a coating composition. The liquid medium may be a medium such as water or other aqueous solutions in which the hydrophilic colloid are dispersed with or without the presence of surfactants. A preferred barrier layer may acts as a gas barrier or a moisture barrier and may comprise SiOx, AlOx or ITO. The protective layer, for example, an acrylic hard coat, functions to prevent laser light from penetrating to functional layers between the protective layer and the substrate, thereby protecting both the barrier layer and the substrate. The functional layer may also serve as an adhesion promoter of the conductive layer to the substrate.

In another embodiment, the polymeric support may further comprise an antistatic layer to manage unwanted charge build up on the sheet or web during roll conveyance or sheet finishing. In another embodiment of this invention, the antistatic layer has a surface resistivity of between 10⁵ to 10¹². Above 10¹², the antistatic layer typically does not provide sufficient conduction of charge to prevent charge accumulation to the point of preventing fog in photographic systems or from unwanted point switching in liquid crystal displays. While layers greater than 10⁵ will prevent charge buildup, most antistatic materials are inherently not that conductive and in those materials that are more conductive than 10⁵, there is usually some color associated with them that will reduce the overall transmission properties of the display. The antistatic layer is separate from the highly conductive layer of ITO and provides the best static control when it is on the opposite side of the web substrate from that of the ITO layer. This may include the web substrate itself.

Another type of functional layer may be a color contrast layer. Color contrast layers may be radiation reflective layers or radiation absorbing layers. In some cases, the rearmost substrate of each display may preferably be painted black. The color contrast layer may also be other colors. In another embodiment, the dark layer comprises milled nonconductive pigments. The materials are milled below 1 micron to form “nano-pigments”. In a preferred embodiment, the dark layer absorbs all wavelengths of light across the visible light spectrum, that is from 400 nanometers to 700 nanometers wavelength. The dark layer may also contain a set or multiple pigment dispersions. Suitable pigments used in the color contrast layer may be any colored materials, which are practically insoluble in the medium in which they are incorporated. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolinone and isoindolinic, polycyclic pigments such as phthalocyanine, quinacridone, perylene, perinone, diketopyrrolo-pyrrole, and thioindigo, and anthriquinone pigments such as anthrapyrimidine. The functional layer may also comprise a dielectric material. A dielectric layer, for purposes of the present invention, is a layer that is not conductive or blocks the flow of electricity. This dielectric material may include a UV curable, thermoplastic, screen printable material, such as Electrodag 25208 dielectric coating from Acheson Corporation. The dielectric material forms a dielectric layer. This layer may include openings to define image areas, which are coincident with the openings. Since the image is viewed through a transparent substrate, the indicia are mirror imaged. The dielectric material may form an adhesive layer to subsequently bond a second electrode to the light modulating layer.

The display may also have incorporate layers or coating that provide for anti reflection and antiglare as well as for soil resistant environmental protection layer including fingerprint protection and wipeability.

Antistatic Layers

In another embodiment, the polymeric support may further comprise an antistatic layer to manage unwanted charge build up on the sheet or web during roll conveyance or sheet finishing. Since the liquid crystal are switched between states by voltage, charge accumulation of sufficient voltage on the web surface may create an electrical field that when discharged may switch a portion of the liquid crystal. It is well know in the art of photographic web based materials that winding, conveying, slitting, chopping and finishing can cause charge build on many web based substrates. High charge buildup is a particular problem with plastic webs that are conductive on one side but not on the other side. Charges accumulates on one side on the web to the point of discharge and in photographic light sensitive materials that discharge can result in fog which is uncontrolled light exposure as a result of the spark caused from the discharge. Similar precaution and static management is necessary during manufacturing or in end use applications for liquid crystal displays. In another embodiment of this invention, the antistatic layer has a surface resistivity of between 10⁵ to 101². Above 10¹², the antistatic layer typically does not provide sufficient conduction of charge to prevent charge accumulation to the point of preventing fog in photographic systems or from unwanted point switching in liquid crystal displays. While layers greater than 10⁵ will prevent charge buildup, most antistatic materials are inherently not that conductive and in those materials that are more conductive than 10⁵, there is usually some color associated with them that will reduce the overall transmission properties of the display. The antistatic layer is separate from the highly conductive layer of ITO and provides the best static control when it is on the opposite side of the web substrate from that of the ITO layer. This may include the web substrate itself.

Pigmented Layers

One type of functional layer useful for liquid crystals may be a color contrast layer. Color contrast layers may be radiation reflective layers or radiation absorbing layers. In some cases, the rearmost substrate of each display may preferably be painted black. The black paint absorbs infrared radiation that reaches the back of the display. In the case of the stacked cell display, the contrast may be improved by painting the back substrate of the last visible cell black. The paint is preferably transparent to infrared radiation. This effectively provides the visible cell with a black background that improves its contrast, and yet, does not alter the viewing characteristics of the infrared display. Paint such as black paint, which is transparent in the infrared region, is known to those skilled in the art. For example, many types of black paint used to print the letters on computer keys are transparent to infrared radiation. In one embodiment, a light absorber may be positioned on the side opposing the incident light. In the fully evolved focal conic state, the chiral nematic liquid crystal is transparent, passing incident light, which is absorbed by the light absorber to create a black image. Progressive evolution of the focal conic state causes a viewer to perceive a reflected light that transitions to black as the chiral nematic material changes from planar state to a focal conic state. The transition to the light transmitting state is progressive, and varying the low voltage time permits variable levels of reflection. These variable levels may be mapped out to corresponding gray levels, and when the field is removed, the light modulating layer maintains a given optical state indefinitely. This process is more fully discussed in U.S. Pat. No. 5,437,811, incorporated herein by reference.

The color contrast layer may also be other colors. In another embodiment, the dark layer comprises milled nonconductive pigments. The materials are milled below 1 micron to form “nano-pigments”. Such pigments are effective in absorbing wavelengths of light in very thin or “sub micron” layers. In a preferred embodiment, the dark layer absorbs all wavelengths of light across the visible light spectrum, that is from 400 nanometers to 700 nanometers wavelength. The dark layer may also contain a set or multiple pigment dispersions. For example, three different pigments, such as a Yellow pigment milled to median diameter of 120 nanometers, a magenta pigment milled to a median diameter of 210 nanometers, and a cyan pigment, such as Sunfast® Blue Pigment 15:4 pigment, milled to a median diameter of 110 nanometers are combined. A mixture of these three pigments produces a uniform light absorption across the visible spectrum. Suitable pigments are readily available and are designed to be light absorbing across the visible spectrum. In addition, suitable pigments are inert and do not carry electrical fields.

Suitable pigments used in the color contrast layer may be any colored materials, which are practically insoluble in the medium in which they are incorporated. The preferred pigments are organic in which carbon is bonded to hydrogen atoms and at least one other element such as nitrogen, oxygen and/or transition metals. The hue of the organic pigment is primarily defined by the presence of one or more chromophores, a system of conjugated double bonds in the molecule, which is responsible for the absorption of visible light. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolinone and isoindolinic, polycyclic pigments such as phthalocyanine, quinacridone, perylene, perinone, diketopyrrolo-pyrrole, and thioindigo, and anthriquinone pigments such as anthrapyrimidine, triarylcarbonium and quinophthalone. For electrophorteic, electrowetting and other types of reflective displays it is useful to have a highly reflective white surface. Such a surface may formed by the application of a white pigment and binder that is coated on a polymeric base or it may be a pigmented compounded in a thermally processable polymer such as polyolefin, polyesters, polycarbonate, polyamides and copolymers thereof. Useful pigments may include but are not limited to TiO2, BaSO4, and ZnS. Other useful white materials are voided polymer sheet that have air voids and pigments and or polymer interfaces that create a highly reflective surface.

Dielectric Material

The curable material may comprise a dielectric material. A dielectric layer, for purposes of the present invention, is a layer that is not conductive or blocks the flow of electricity. This dielectric material may include a UV curable, thermoplastic, screen printable material, such as Electrodag 25208 dielectric coating from Acheson Corporation. The dielectric material forms a dielectric layer. This layer may include openings to define image areas, which are coincident with the openings. Since the image is viewed through a transparent substrate, the indicia are mirror imaged.

The dielectric material may form an adhesive layer to subsequently bond a second electrode to the light modulating layer. Conventional lamination techniques involving heat and pressure are employed to achieve a permanent durable bond. Certain thermoplastic polyesters, such as VITEL 1200 and 3200 resins from Bostik Corp., polyurethanes, such as MORTHANE CA-100 from Morton International, polyamides, such as UNIREZ 2215 from Union Camp Corp., polyvinyl butyral, such as BUTVAR B-76 from Monsanto, and poly(butyl methacrylate), such as ELVACITE 2044 from ICI Acrylics Inc. may also provide a substantial bond between the electrically conductive and light modulating layers.

The dielectric adhesive layer may be coated from common organic solvents at a dry thickness of one to three microns. The dielectric adhesive layer may also be coated from an aqueous solution or dispersion. Polyvinyl alcohol, such as AIRVOL 425 or MM-51 from Air Products, poly(acrylic acid), and poly(methyl vinyl ether/maleic anhydride), such as GANTREZ AN-119 from GAF Corp. can be dissolved in water, subsequently coated over the second electrode, dried to a thickness of one to three microns and laminated to the light modulating layer. Aqueous dispersions of certain polyamides, such as MICROMID 142LTL from Arizona Chemical, polyesters, such as AQ 29D from Eastman Chemical Products Inc., styrene/butadiene copolymers, such as TYLAC 68219-00 from Reichhold Chemicals, and acrylic/styrene copolymers such as RayTech 49 and RayKote 234L from Specialty Polymers Inc. can also be utilized as a dielectric adhesive layer as previously described.

Conductive Layer

The electromodulating display contains at least one conductive layer. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.). Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃. The conductive layer may be formed, for example, by a low temperature sputtering technique or by a direct current sputtering technique, such as DC-sputtering or RF-DC sputtering, depending upon the material or materials of the underlying layer. The conductive layer may be a transparent, electrically conductive layer of tin oxide or indium-tin oxide (ITO), or polythiophene, with ITO being the preferred material. Typically, the conductive layer is sputtered onto the substrate to a resistance of less than 250 ohms per square. Alternatively, conductive layer may be an opaque electrical conductor formed of metal such as copper, aluminum or nickel. If the conductive layer is an opaque metal, the metal can be a metal oxide to create a light absorbing conductive layer.

Indium tin oxide (ITO) is the preferred conductive material, as it is a cost effective conductor with good environmental stability, up to 90% transmission, and down to 20 ohms per square resistivity. An exemplary preferred ITO layer has a % T greater than or equal to 80% in the visible region of light, that is, from greater than 400 nm to 700 nm, so that the film will be useful for display applications. In a preferred embodiment, the conductive layer comprises a layer of low temperature ITO which is polycrystalline. The ITO layer is preferably 10-120 nm in thickness, or 50-100 nm thick to achieve a resistivity of 20-60 ohms/square on plastic. An exemplary preferred ITO layer is 60-80 nm thick.

The conductive layer is preferably patterned. The conductive layer is preferably patterned into a plurality of electrodes. The patterned electrodes may be used to form a LCD device. In another embodiment, two conductive substrates are positioned facing each other and cholesteric liquid crystals are positioned therebetween to form a device. The patterned ITO conductive layer may have a variety of dimensions. Exemplary dimensions may include line widths of 10 microns, distances between lines, that is, electrode widths, of 200 microns, depth of cut, that is, thickness of ITO conductor, of 100 nanometers. ITO thicknesses on the order of 60, 70, and greater than 100 nanometers are also possible.

When applying a metal oxide to a conductive trench, it may be desirable to apply the metal oxide to a pre-trenched polymer sheet that allows the metal to deposit into the trench and sidewalls. Since the application is over a broad area, some of the metal oxide needs to be removed to provide electrical isolation from other areas that are driven or activated separately from other areas. The removal may is achieved by any method known in the art such as laser ablation, chemical etching with the further application of a patterned photoresist on top of the metal oxide or by the application of a patterned removable layer (material with little or no adhesion to the polymer sheet) to the polymer sheet prior to the metal oxide application. After the application of the metal oxide, the patterned removable layer may be wash away, leaving the metal oxide only in those areas that did not contain the removal layer.

Materials other than metal oxide are described above. These include but are not limited to polythiophene, Ag, Au, Al, Cu, Ni, Zn as well as the addition of a precursor in the trench such as pallidum and growing a metal with an electroysis plating process.

Drivers—

The displays may employ any suitable driving schemes and electronics known to those skilled in the art, including the following, all of which are incorporated herein by reference in their entireties: Doane, J. W., Yang, D. K., Front-lit Flat Panel Display from Polymer Stabilized Cholesteric Textures, Japan Display 92, Hiroshima October 1992; Yang, D. K. and Doane, J. W., Cholesteric Liquid Crystal/Polymer Gel Dispersion: Reflective Display Application, SID Technical Paper Digest, Vol XXIII, May 1992, p. 759, et sea.; U.S. patent application Ser. No. 08/390,068, filed Feb. 17, 1995, entitled “Dynamic Drive Method and Apparatus for a Bistable Liquid Crystal Display” and U.S. Pat. No. 5,453,863.

The term display in the simplest form is an electromodulating device with row and column electrodes in which an electric field causes a material to light shift or modulate. A pixelated display is an array of cell formed by row and column electrodes with independent control for varying the electrical field intensity for each pixel. Electromodulating material associated with each pixel can then shift in response to the field changes. A cross-over is two or more electrodes that intersect each other at different height planes. They are usually separated by a dielectric or otherwise insulting material. An electrode is a conductive material typically in but not limited to a line. A busbar is a highly conductive electrode that supplies or feeds other electrodes or electrical devices. A gate electrode is an electrode that controls the movement of materials that have an electrical charge. By making the gate electrode the same charge as the electromodulating material, the material will be electrical repelled from the gate and therefore it will prevent the material from moving to other areas of the pixel. A collector is an electrode that is used to assemble or otherwise attract and hold electomodulating materials. The collector electrode attracts the material using a an opposite charge that the material. It usually is a small area outside of the viewing area for the pixel.

A helper is an electrode used to assist the movement of materials so as to spread them out in a somewhat uniform manner. Typically the electrical field lines are more intense on the edges and the electromodulating material will tend to concentrate on the edge closes to the particles. By applying a slightly more intense electrical field on the opposite edge, the material will tend to spread out more uniformily over a larger area.

A flag is an electrode (also called a view electrode) is area in which material is moved for viewing. The area footprint is much larger than the other electrodes. The electromodulating material is spread out for easier viewing. By moving material in and out of the flag area, the color of the pixel can be changed. Walls or microcells contain material and in particular liquids. In an electromodulating display, each pixel has walls in order to contain electrodmodulating material. The top and bottom of the microcells are sealed so the material stays in the desired area. The micorcells useful in this invention have walls on four sides and may have a depth of 0.5 to 100 microns. The microcells form a continuous array of cups that can contain and hold liquids. The microcells may be formed by impressing or forming them into a polymer, photo imaging them into a layer that is sensitive to light or thermal energy.

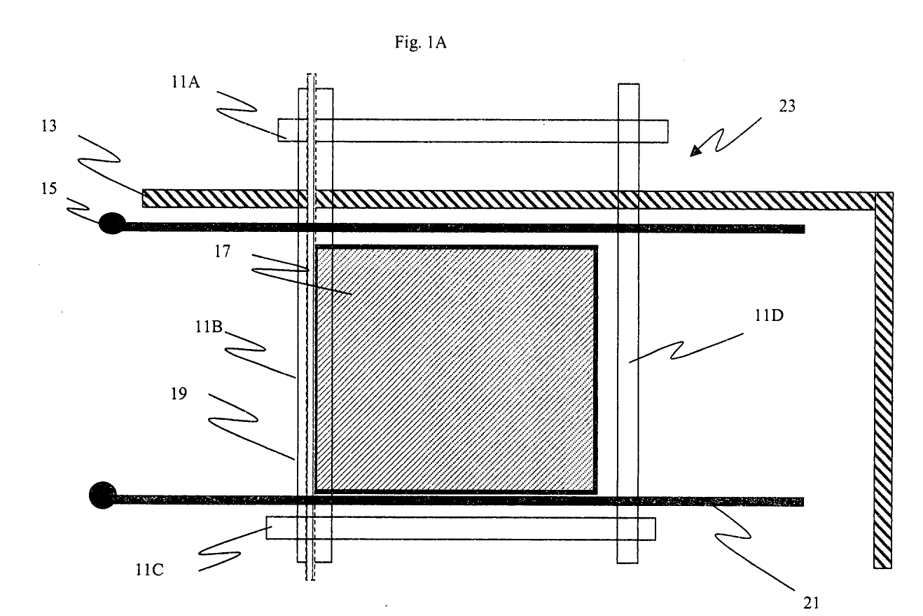

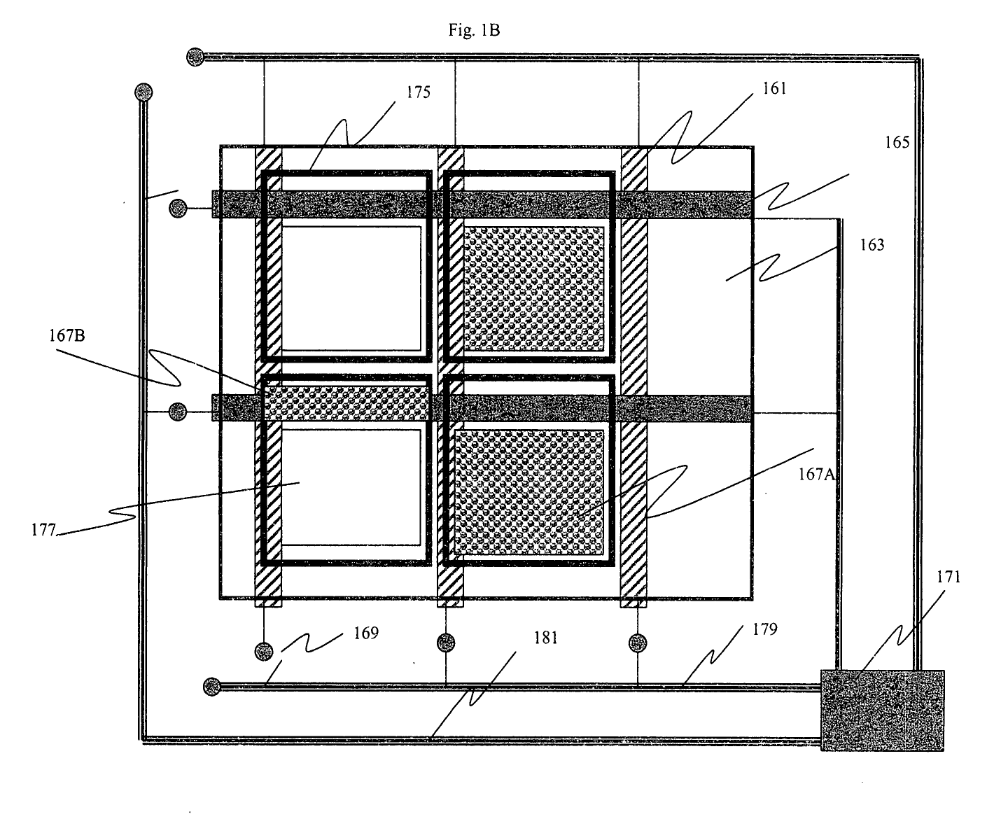

FIG. 1A is a top view of a typical pixel. The display pixel 23 comprises a micro-cell with four walls (11A, 11B, 11C and 11D) that are capable of holding an electromodulating fluid. The display pixel also has a bus-bar 19 that has high conductivity and runs below the surface plane of the pixel and is also under micro-cell wall 11B. Bus-bar 19 forms electrical crossover regions with collector electrode 13 and gate electrode 15 and helper electrode 21. The cross over region is electrically isolated from the other electrodes because the conductive material is in a trench below the surface of the display pixel. Additionally (not shown in this FIG. 1A) a dielectric material that provides electrical isolation from collector electrode 13, gate electrode 15 and helper electrode 21 is located. Display pixel 23 also has a flag electrode 17 that provides an electrical field over a large are of the pixel. This provides a way to spread the electrode modulating material over a larger viewing area. By bringing the electrode modulating material in and out of the flag electrode area, the pixel can change color.

In a preferred embodiment of this, FIG. 1B is a simple column and row select display in which either a positive, negative or open electric field is applied to individual pixels. The display consists of a grooved polymer sheet 163 (could be either transparent or opaque), row electrodes 165 and column electrodes 161 as well as a flag electrode 177. Each pixel is defined by a wall structure 175 that is capable of holding a medium that can shift in response to the switching of the electric field orientation. 167A and 167B denotes such a medium that can shift when changes are made to the electric field. 171 is a device for applying an electric field to both the rows via electrical feed 181 and columns via electrical feed 179 and 169 is a switch that can open or close an electrode.

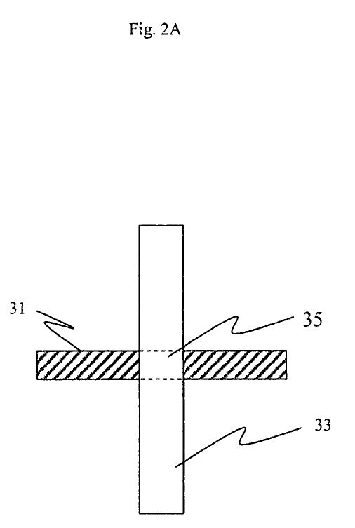

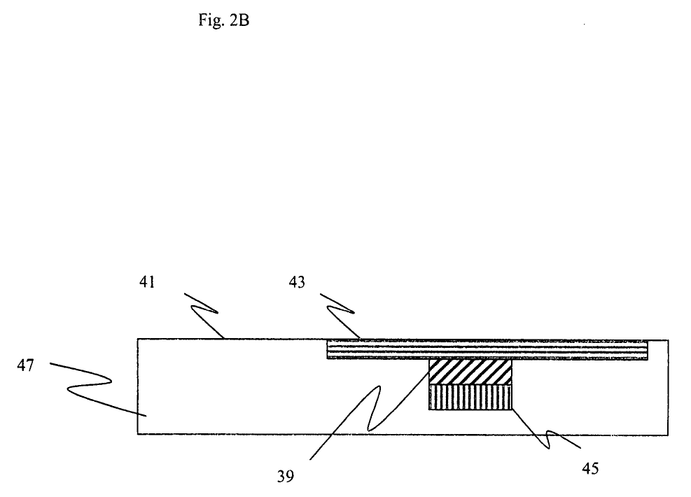

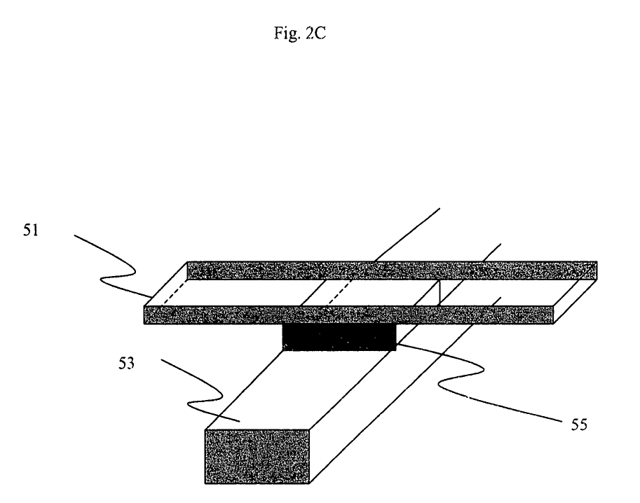

FIG. 2A is a top view of an electrical cross-over with electrodes 31 and electrode 33 that cross-over each other to form a cross-over region 35.

A preferred embodiment FIG. 2B is a cross sectional view of two electrodes 43 and 45 that have been form in a trench with support substrate 47. A dielectric 39 separate electrodes 43 and 45. As shown in this figure the two electrodes and the dielectric layer are below the support substrate surface 41. Being able to provide conductive trenches that are below the polymer sheet surface is useful in reducing wear and tear on thin fragile electrodes that can easily be damaged or broken and therefore render the display defective or perhaps useless. By applying a dielectric or insulating material on top of the conductive material in the trench, a second conductive electrode may be crossed over the first electrode without causing an electrical short. Since each pixel of a display has multiple regions that need to be controlled separately from each other as well as to adjoining pixels, it is desirable to form cross-overs of more than conductor. Being able to place them in trenches as opposed to forming them on the surface is also useful to the visual appears of the display, otherwise each crossover point would create a lump or hump that uses extra area within the display.

FIG. 2C is a perspective view of electrode 51 and electrode 53 crossing over each other and separated by dielectric 55. This most preferred embodiment is useful because it only applies the dielectric material at the point of the crossover. This is a more efficient use of materials and is less time consuming than applying dielectrical material over the entire area of the trench.

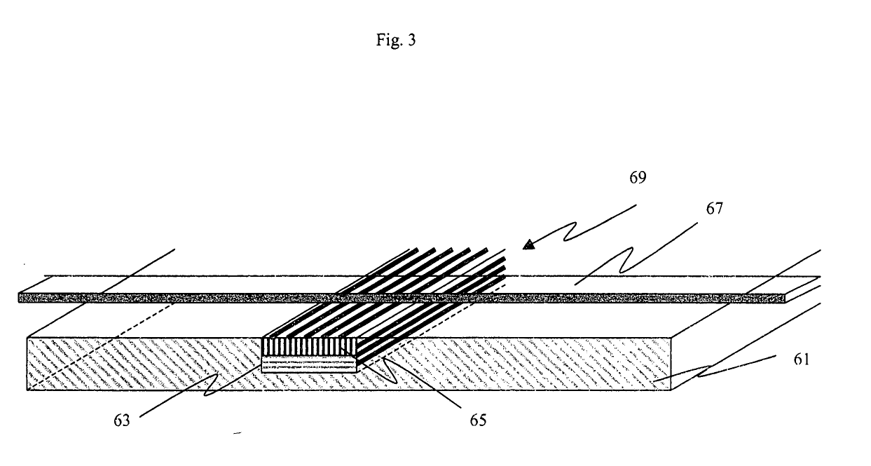

FIG. 3 is a perspective cross-sectional view of a support substrate (polymer sheet) with an electrical cross over. The polymer sheet 61 comprises a support of plastic material with channel (trench) 69 that has been filled with an electrical conductive material to form electrode 63 that is below the surface of the polymer sheet. A dielectric material 65 is place on top of electrode 63. A second conductive material 67 is placed on top of the dielectric and also on top of the polymer sheet 61 and at an angle to the filled channel containing electrode 63 and dielectric 65 to form an area of an electrical crossover. Having electrode contained within trenches as well as on the surface of the polymer sheet is useful to help assure better manufacturability. The advantage is to have different conductive materials that are applied to the polymer sheet using different methods such as patterned printing, sputtering, micro-pen dispensing or other methods known in the art.

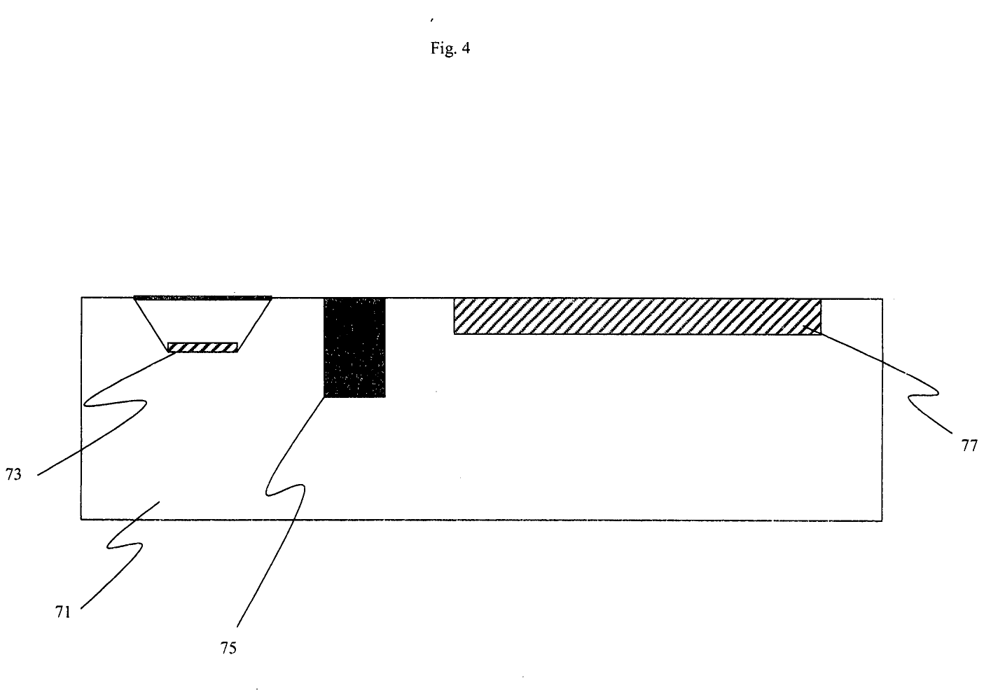

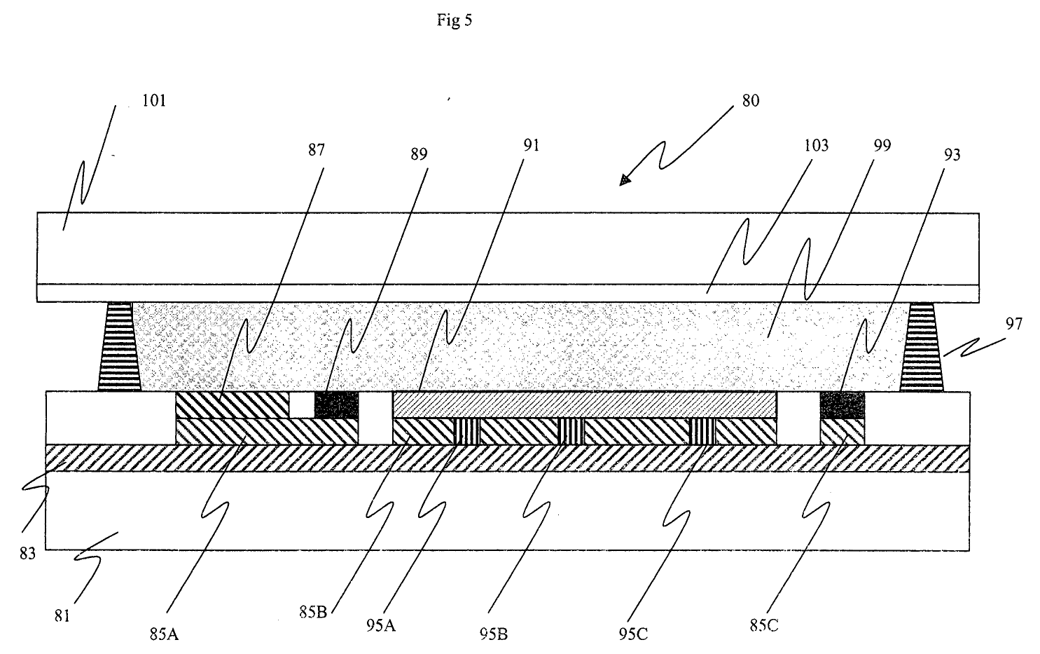

In another embodiment of this invention FIG. 4 is a cross sectional view of a micro-replicated polymer base 71 that has multiple trench regions at different depths and shapes. The regions form three electrodes consisting of collector electrode 73, gate electrode 75 and flag electrode 77. Multiple or variable depth in a display are useful for providing region within the display that are more conductive than other. Some areas may not have the need for a cross-over and such areas are more useful if they are closer to the surface of the polymer sheet. For the collector electrode, it may be useful to have a deep trench in order to pull a high volume of electromodulating material out of the viewing area. Having a shape or height transiting to the trenches is useful to help shape the electrical field such that material can be moved into and out of the trench more efficiently FIG. 5 is a cross-sectional view of a preferred embodiment of this invention with display pixel 80 that consist of trenched polymer sheet 81 that has a bus-bar electrode 83, dielectric regions 85A, 85 B and 85 C, Collector electrode 87, gate electrode 89, view or flag electrode 91 and helper electrode 93 on the surface of trenched polymer sheet 81. View (flag) electrode 91 is connected to bus-bar electrode 83 by via holes 95 A, 95 B and 95C that have been filled with a conductive material. While three vias are shown in this figure, more or less may be useful in providing uniform electrical field or reducing the complexity and cost of the display. On the polymer sheet surface are walls 97 (only ends are shown because of the 2D view) that form a micro-cell that can hold electrodmodulating fluid 99. Fluid 99 is sealed to the micro-cell by polymer sheet 101 and adhesive layer 103. While this figure shows an adhesive sheet as the means of sealing the microcell, other means may also be useful. These may include the use of a liquid polymer adhesive that adheres to the top of the wall and floats on top of the electromodulating fluid. The polymer may be placed on top and the solvent portion evaporated or in may be a photo or chemical crossed linked monomers that forms a polymer. This may include phase separating materials.

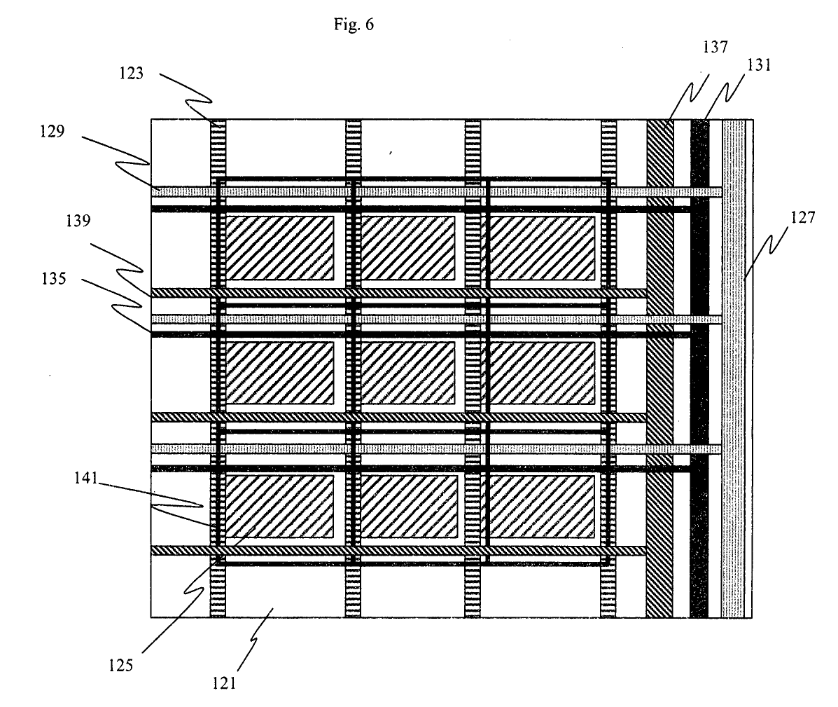

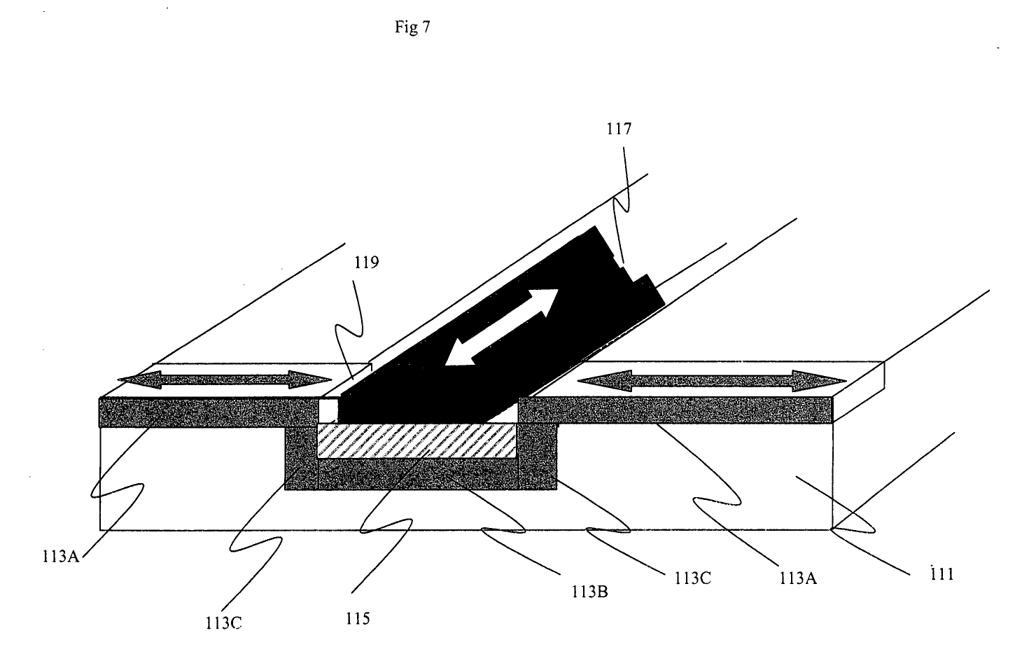

FIG. 6 is a top view of a preferred electromodulating display embodiment with more than one display pixel that starts to form the rows and columns. It provides a view of the electrical feed from the bus-bars and illustrates the large number of electrical crossovers for such a display in order to provide individual addressability for each pixel. For a typically display with 30 to 50 DPI resolution, there are thousands of pixel per square inch. Being able to provide sub-surface electrical feed and electrical isolation at the cross over points is an important aspect of making a visually appealing display. Being able to provide transparent electrodes for some or all of the electrodes is critical if a stacked multi-color display is made. FIG. 6 consists of trenched polymer sheet 121 that has separate trenches for flag electrode bus-bar 123A that feeds flag electrode 125, collector electrode bus-bar 127 that feeds collector electrode 129, gate electrode bus-bar 131 that feeds gate electrode 135 and helper electrode 137 that feeds helper electrode 139. On top of the polymer sheet is a network of cells walls 141 that contain an electromodulating fluid. Since this figure is a top view not shown are the fluid and means of sealing. This figure provides a top view and demonstrate the potential complexity of a simple display In another embodiment of this invention, FIG. 7 illustrates another electrical crossover. A polymeric substrate 111 with formed trenches in an x,y plane consists of electrode 1 that is made-up of sections 113A, 113B, and 113C. Dielectric material 115 is applied on top of section 113B so as to provide electrical insulation from electrode 2 shown by 117 that runs in another direction than electrode 1. A dielectric 119 needs to be placed between electrode 1 and 2 since they intersect in the same plane. As shown in FIG. 7 an air gap serves as the dielectric. The air gap may be formed either by patterning electrode 117 such that it does not contact sections 113A of electrode 1 or electrode 117 may be applied to fill the trench and then ablated away so it does not physical contact electrode 1. This method minimizes the amount of trenches that need to be formed since they only occur at the point of the cross-over.

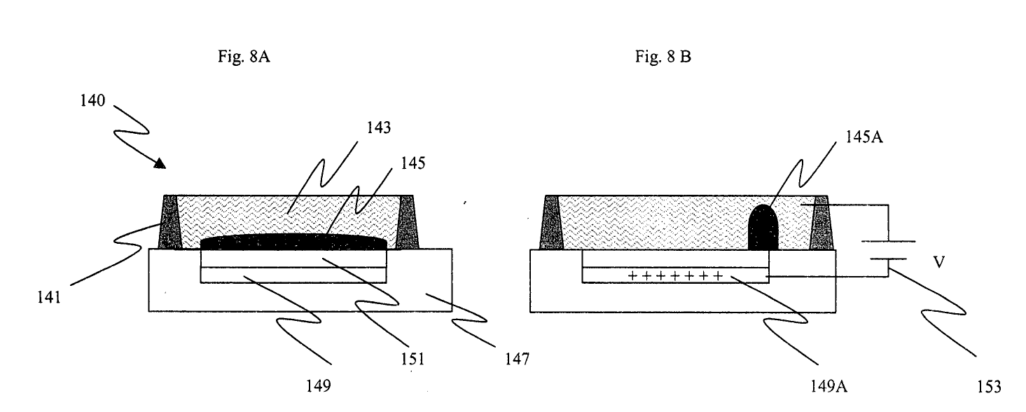

FIGS. 8 A and 8 B illustrate an electrowetting cell 140 with two non-miscible fluids (143 and 145) in the cell. The cell is defined on the side by wall structure 141 and trenched polymer sheet 147 with hydorphobic insulator 151. Electrode 149 is in the base of the trench and hydrophobic insulator 151 in on top. Fluid 145 may have a color associated with it. Additionally fluid 145 is shifted when and electrical field is applied to conductor 149A causing the fluid 145 A to move to one side and out of the viewing aperture. In FIG. 8 B a voltage is applied causing fluid shift in response to the change in electric field via voltage application 153.

In a preferred embodiment of this invention the electromodulating display of comprises an array of sealed cells. The cells useful in this invention may also be referred to has micro-cells which provides a conutation of small size. These cells may be square, rectangular, round or other shape. There purpose is to contain or otherwise hold an electromodulating material such as a fluid and or a medium that is optically shifted in response to the switching of the electric field orientation. In this manner the fluid or particles may be moved from one side of the micro-cell so as to remove all or part of the material from the viewing portion of a micro-cell. Each micro-cell forms an individual pixel that can be electrically addressed (written). When the material is moved out of the viewing portion of the cell, the next layer or background is observed. This changes the color observed in that pixel. The electromodulating display useful in this invention provides an array of micro-cells. By addressing each cell within the array of cells, letters, characters, number and other images may be formed by color contrast between adjacent cells or in the case of a stacked display with many color the image may change color and contrast by opening and closing the cell aperture on top of one another.

In either a stacked full color display or a single mono-chromatic the electromodulating display the electrically-conductive material used to fill the plurality of patterned grooves containing is opaque. Conductive opaque materials are more readily available than transparent conductors and typically can achieve conductivities much lower than their transparent counterparts. This is useful for primary supply lines or busbars that need to provide electrical power to hundreds and thousands of cells (pixels). This is useful to assure that the information contained within the display can be updated and changed in a timely manner. If insufficient power is applied to a cell or pixel, the electromodulating material may only partially move or respond to the applied electrical filed and affect the color intensity. The opaque more conductive features help to assure of adequate and uniform power to all cells or pixels. In an additional embodiment of this invention both opaque and transparent electrodes are preferred. As discussed above the primary busbars may be opaque but the flag electrodes may be transparent or semi-transparent. This is useful in stacked full color displays in which you need to view through a flag electrode of one layer to see the flag electrode on the display layer below it or to see the background such as a white reflector layer.

Useful opaque electrically-conductive material that can be used in the embodiments of this invention may comprises at least one material selected from the group consisting of silver, gold, aluminum, zinc, copper. Other metallic materials known in the field of conductive metal may also be used. Both transparent and opaque organic conductors such as polythophene, polyanaline and others may also be useful. As discussed in other sections of this patent, the flag electrode may be transparent. Typically the flag electrode as well as the gate, collector and helper electrode may be less conductive than the primary busbar supply electrodes. The electrically-conductive material may a conductivity of less than 5000 ohms/sq. Electromodulating displays may have electrical features that need varying levels of power. A busbar may need a conductivity of less than 10 ohms/sq. while a flag electrode may need only a few hundred to thousands ohms/sq. to operate.

Other useful embodiments in this invention provide vias holes. A via is a hole that can be drilled or otherwise form that connects two layers. The via is filled with a conductive material and allows two conductive features in different Z-dimensional planes to be connected. In a preferred embodiment of this invention, a via may connect a conductive electrode (perhaps a busbar) below the surface of the polymer sheet through an insulting layer to another electrode that is on the surface (ie. a flag electrode) or at least in a different Z-dimensional plane.

Since the displays useful in this invention are made on plastic, it is preferred that they can be bent. By providing conductive features that are closer to the center of bending of the display, any stress applied in compression or expansion would be applied in a more uniform manner and would most likely result in less cracking or breakage of the electrical feature that would render the display useless or at least defective in a row or column.

In an embodiment of this invention the electromodulating display with a plurality of patterned grooves containing an electrically-conductive material and also an electrical insulating material. The insulating material provides electrical isolation between two or more conductors such that they do not intefere with each other such as an electrical short or drain to ground. Having both material one on top of the other in the trench with a lower conductor and upper insulating material provides a design that allows a second conductor either in a trench or on the surface to form a region where the two crossover each other. Crossovers are an essential part of a multi micro-cell array. Other embodiments of this would be to have one trench with only a conductor crossover (actually cross-under) a second trench in which the insulator is located in the lower part of the trench and the conductor in the upper portion of the trench.

In another embodiment of this invention the electromodulating display containing a plurality of patterned grooves containing two or more electrically conductive materials separated by at least one electrical insulating material. These filled trenches may also form crossovers. This implies that the upper most conductor is at or near the surface of the polymer sheet. Another embodiment would be to have two or more conductor with two or more insulators. The advantage of this is to minimize the number of electrode in the array. By stacking them within different planes of the polymer sheet, the viewing surface of the each micro-cell or pixel is maximized. This provides a display that is more colorful and intense. This is more appealing the viewer and is therefore more efficient in communicating a message and grabbing the attention of a potential consumer. This will help to increase sales when this type of display is used for advertisement.

In another embodiment of this invention a method of making a microcell for an electromodulating display contains a nonconductive polymeric unitary substrate containing a plurality of patterned grooves containing an electrically-conductive material and further forming a plurality of patterned grooves integrally in the substrate; and then introducing a first electrically conductive material into the groove partly filling the groove; and then applying a dielectric on top of all or part of the conductive material in the groove. A second conductive layer is patterned to form cross-over regions with the first electrical conductive material and dielectric material. On the surface of the substrate microcells are formed using a patternable photopolymer. The microcells are then filled with medium that is optically shifted in response to the switching of the electric field; and then a separate cover sheet with a polymeric layer is used sealing the medium in the microcells. The electrodes that were formed by the plurality of grooves are attached to an electrical drive than can switches voltages causing the particles to shift from one electrode area to another.

The nonconductive polymer unitary substrate with a plurality of patterned grooves may be either transparent or opaque polymer such as polyester, polycarbonate, PMMA, polyolefin, acetate or polysulfone. If an opaque substrate is desired pigments may be added. The choice of pigments in most cases is a white reflective material such as TiO2, BaSO4, ZnO, CaCO3, clay or other pigments known in the art. If another color is desired then other pigments may be used. The plurality of grooves may be formed by either etching the substrate with a micro scribe stylus or laser ablation process. The plurality of grooves may also be micro-replicated into the substrate at the time it is made. This process essentially involves heating the polymer to or slightly above its melting point and then casting the molten polymer into a nip formed by two rollers or a roller and a belt or two belts. The plurality of grooves is engraved or otherwise formed in at least one of the rollers or belts as a negative image of what is desired in the final substrate. The molten polymer replicates the desired patterned to form a unitary substrate with a plurality grooves. The groove pattern may be in any shape or form that is necessary to form a display device. This may include but is not limited to a network of grooves, trenches or conduit that intersect or pass over each other in some areas or run parallel to each other in other areas. The term groove as used herein does not limit the shape, depth or width ratio of top to bottom of the groove. In the process of forming the plurality of grooves it may be desirable for the molten polymer to contact one roller or belt prior to entering the nip formed by the two rollers or belts. This may enable better heat transfer and replication of the pattern. This may also be beneficial to minimize cross lines or other imperfections that may occur during manufacture. It may also be desirable to provide temperature control of the rollers and belts to optimize the replication process as well as to control the pressure in the nip or point of polymer contact to the first pattern roller or belt.

The grooves that are formed as part of the substrate may be filled with a conductive material as describe above. The groove may be partly or completely filled to the desired thickness and conductivity. Typically methods may include but are not limited to coating or pattern applying a conductive material from either water or solvent and then evaporate off the fluid portion leaving the solid portion in part of the groove. The conductive material may also be vacuum deposited into the grooves. The application of the dielectric may also be applied in a similar manner. At points of crossovers (two or more intersecting conductive grooves), it may be desirable to pattern a dielectric only in the proximity of the cross-over intersection. This will minimize the amount of material required.

The microcell used in this embodiment may be formed by photo sensitive photo epoxy such as SU8 type 2010 manufactured by MicoChem. The SU8 may be either spun coated to form a uniform layer thickness that is desired (approx. 3000 RPM's for a 10 micron thick layer) and soft and hard baked according to the manufacture instruction for time and temperature. A photomask with the desired microcell structure is placed in contact with the SU8 layer and then given a UV exposure. This is followed by a hard bake process and then the layer is developed using SU8 Developer also available from MicroChem. The sample is then washed with methanol. The result process provides a continuous array of microcell. Typically this may be a cell size of 200 to 500 microns and a wall thickness of 10 to 20 microns and a depth of approximately 10 microns. These dimensions may be varied to achieve a display with finer or courser pixels.

The filling and sealing of the microcells with a medium (fluid dispersion) that response to an electrical filed, may be applied to the microcells by flooding the surface and scraping off the excessive medium or by using rollers in a nip to force the medium into the cells. The pressure in the nip acts as scraping technique that removes the excess medium. A cover sheet with an adhesive may be heat sealed to trap the medium in the cells. Other method may include the formation of a polymer skin on the surface of the medium that provides a seal so the medium does not leak out of the cells.

In another embodiment electromodulating display method describe above further comprises a surface patterning of electrode features. It may be desirable to have some surface feature electrodes in combination with the plurality of conductive grooves. For instance a busbar that supply voltage to an array of several cells needs to be more conductive than the electrodes that switch an individual cell. This may be more easily achieved by applying a highly conductive material on the surface. Such material may be solution coated or printed in a patterns or sputter coated and ablated to form a highly conductive busbar. The plurality of conductive grooves are useful in that they may be at a different depth than the surface busbar. In a dielectric is applied over the conductive material, it is easy to form a crossover point without adding excessive height to the display. The reduction in added thickness is useful for flexible and conformal displays.

While thermoplastic materials offer good chemical and heat resistance, the addition of nano-composite materials such as clay to the conduits further improve the heat resistance, electrical insulation properties and abrasion resistance while not significantly reducing the transmission properties of the conductive sheet. By adding pigments or dyes to either the conductive conduits or the insulating thermoplastic structures that contain the conductive materials, the conductive sheet of the invention can provide colored transmission light energy or contain a pattern such as the word “stop” as in a stop sign. These and other advantages will be apparent from the detailed description below.

The term “LCD” means any rear projection display device that utilizes liquid crystals to form the image. The term “diffuser” means any material that is able to diffuse specular light (light with a primary direction) to a diffuse light (light with random light direction). The term “light” means visible light. The term “diffuse light transmission” means the percent diffusely transmitted light at 500 nm as compared to the total amount of light at 500 nm of the light source. The term “total light transmission” means percentage light transmitted through the sample at 500 nm as compared to the total amount of light at 500 nm of the light source. This includes both spectral and diffuse transmission of light. The term “diffuse light transmission efficiency” means the ratio of % diffuse transmitted light at 500 nm to % total transmitted light at 500 nm multiplied by a factor of 100. The term “polymeric film” means a film comprising polymers. The term “polymer” means homo- and co-polymers. The term “average”, with respect to lens size and frequency, means the arithmetic mean over the entire film surface area.

The term “Transparent” means a sheet with total light transmission of 70% or greater at 500 nm. The term “Conduit” or “conduit channel” means a trench, furrow or groove in the sheet of the invention. The conduits in the sheet contain the conductive materials useful in the invention. The conduits range in thickness between 0.5 and 100 micrometers. The conduits have a general direction in the plane of the sheet, although the conduit can vary in the depth of the sheet. Conduits in the plane of the sheet can be ordered rows or arrays, random in nature, straight, curved, circular, oval, square, triangular, sine waves, or square waves. The conduits generally start with an origination point and end at a termination point. The conduits may be discrete or may intersect. In the sheet, there may be one or more conduits. The conduit frequency in any direction ranges from one conduit/cm to 1000 conduits/cm.

The term conductive means the ability of a material to conduct electrical current. Conductivity is the reciprocal of resistivity. Resistivity is measured in units of ohm-meters. A common way of referring to surface resistance of a conductive layer coated on a substrate, is by the term surface electrical resistance or SER. SER is measured in units of ohms/square. Conductive materials utilized in this invention generally have resistivity of less than 5000 ohm meters. Conductive layers utilized in this invention generally have measured SER of less than 5000 ohms/square.

In order to provide a sheet that is patterned to be conductive to electrical current and is transparent to visible light energy, an article comprising a polymer layer containing a plurality of integral polymer conduits containing a substantially transparent conductive material is preferred. The polymer conduits provide electrical insulation between the conduits and the material contained in the conduits is both transparent and electrically conductive. Because the material in the conduits is both conductive and transparent, the article of the invention can be utilized in application that required electrically conductive properties and transparency to visible light. Examples of the utility of the sheet containing a plurality of conduits containing a transparent, conductive materials include simple displays that use a coated layer of cholesteric liquid crystals in which the electrical field of the energized conduits changes the orientation of the cholesteric liquid crystals, rear illuminated watch electronics in which illumination light energy is transmitted through the conductive conduits and transparent hidden radio frequency antenna.

Conductive materials useful in this application may comprise a conductive polymer. Conductive polymers are preferred because they contain the desired visible light transparency properties, can be easily coated roll to roll in the conduits compared to prior art metallic conductors which utilize vacuum deposition methods for application, have resistivity of less than 5000 ohm meter and more typically in the 0.01 to 5000 ohm meter range and can contain addenda such as a transparent dye. Additionally, the conductive polymer useful in the invention have been shown to have excellent adhesion to the bottom of the polymer conduits located in the depth of the polymer sheet.

In order to provide electrically conductive conduits that have a high visible light transmission conductive polymers selected from the group consisting of substituted or unsubstituted aniline containing polymers, substituted or unsubstituted pyrrole containing polymers, substituted or unsubstituted thiophene containing polymers. The above polymers provide the desired conductivity, adhesion to the conduits and have high light transmission.

Among the aforesaid electrically conductive polymers, the ones based on polypyrrole and polythiophene are particularly preferred as they provide optimum electrical and optical properties.

A particularly preferred electrically conductive polymer for the present invention is polythiophene based, mainly because of its commercial availability in large quantity.

The electrically conductive material of the present invention is preferably coated from a coating composition comprising a polythiophene/polyanion composition containing an electrically conductive polythiophene with conjugated polymer backbone component and a polymeric polyanion component. A preferred polythiophene component for use in accordance with the present invention contains thiophene nuclei substituted with at least one alkoxy group, e.g., a C₁-C₁₂ alkoxy group or a —O(CH₂CH₂O)ₙCH₃ group, with n being 1 to 4, or where the thiophene nucleus is ring closed over two oxygen atoms with an alkylene group including such group in substituted form. Preferred polythiophenes for use in accordance with the present invention may be made up of structural units corresponding to the following general formula (I) 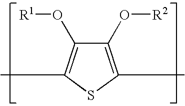
in which: each of R¹ and R² independently represents hydrogen or a C₁₋₄ alkyl group or together represent an optionally substituted C₁₋₄ alkylene group, preferably an ethylene group, an optionally alkyl-substituted methylene group, an optionally C₁₋₁₂ alkyl- or phenyl-substituted 1,2-ethylene group, 1,3-propylene group or 1,2-cyclohexylene group. The preparation of electrically conductive polythiophene/polyanion compositions and of aqueous dispersions of polythiophenes synthesized in the presence of polyanions, as well as the production of antistatic coatings from such dispersions is described in EP 0 440 957 (and corresponding U.S. Pat. No. 5,300,575), as well as, for example, in U.S. Pat. Nos. 5,312,681; 5,354,613; 5,370,981; 5,372,924; 5,391,472; 5,403,467; 5,443,944; and 5,575,898, the disclosures of which are incorporated by reference herein.

The preparation of an electrically conductive polythiophene in the presence of a polymeric polyanion compound may proceed, e.g., by oxidative polymerization of 3,4-dialkoxythiophenes or 3,4-alkylenedioxythiophenes according to the following general formula (II): 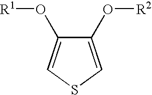
wherein: R¹ and R² are as defined in general formula (I), with oxidizing agents typically used for the oxidative polymerization of pyrrole and/or with oxygen or air in the presence of polyacids, preferably in aqueous medium containing optionally a certain amount of organic solvents, at temperatures of 0° to 1000° C. The polythiophenes get positive charges by the oxidative polymerization, the location and number of said charges is not determinable with certainty and therefore they are not mentioned in the general formula of the repeating units of the polythiophene polymer. When using air or oxygen as the oxidizing agent their introduction proceeds into a solution containing thiophene, polyacid, and optionally catalytic quantities of metal salts till the polymerization is complete. Oxidizing agents suitable for the oxidative polymerization of pyrrole are described, for example, in J. Am. Soc. 85, 454 (1963). Inexpensive and easy-to-handle oxidizing agents are preferred such as iron(III) salts, e.g. FeCl₃, Fe(ClO₄)₃ and the iron(III) salts of organic acids and inorganic acids containing organic residues, likewise H₂ O₂, K₂ Cr₂ O₇, alkali or ammonium persulfates, alkali perborates, potassium permanganate and copper salts such as copper tetrafluoroborate. Theoretically, 2.25 equivalents of oxidizing agent per mol of thiophene are required for the oxidative polymerization thereof [ref. J. Polym. Sci. Part A, Polymer Chemistry, Vol. 26, p. 1287 (1988)]. In practice, however, the oxidizing agent is used in a certain excess, for example, in excess of 0.1 to 2 equivalents per mol of thiophene.

For the polymerization, thiophenes corresponding to the above general formula (II), a polyacid and oxidizing agent may be dissolved or emulsified in an organic solvent or preferably in water and the resulting solution or emulsion is stirred at the envisaged polymerization temperature until the polymerization reaction is completed. The weight ratio of polythiophene polymer component to polymeric polyanion component(s) in the polythiophene/polyanion compositions employed in the present invention can vary widely, for example preferably from about 50/50 to 15/85. By that technique stable aqueous polythiophene/polyanion dispersions are obtained having a solids content of 0.5 to 55% by weight and preferably of 1 to 10% by weight. The polymerization time may be between a few minutes and 30 hours, depending on the size of the batch, the polymerization temperature and the kind of oxidizing agent. The stability of the obtained polythiophene/polyanion composition dispersion may be improved during and/or after the polymerization by the addition of dispersing agents, e.g. anionic surface active agents such as dodecyl sulfonate, alkylaryl polyether sulfonates described in U.S. Pat. No. 3,525,621. The size of the polymer particles in the dispersion is typically in the range of from 5 nm to 1 μM, preferably in the range of 40 to 400 nm.

Polyanions used in the synthesis of these electrically conducting polymers are the anions of polymeric carboxylic acids such as polyacrylic acids, polymethacrylic acids or polymaleic acids and polymeric sulfonic acids such as polystyrenesulfonic acids and polyvinylsulfonic acids, the polymeric sulfonic acids being those preferred for this invention. These polycarboxylic and polysulfonic acids may also be copolymers of vinylcarboxylic and vinylsulfonic acids with other polymerizable monomers such as the esters of acrylic acid and styrene. The anionic (acidic) polymers used in conjunction with the dispersed polythiophene polymer have preferably a content of anionic groups of more than 2% by weight with respect to said polymer compounds to ensure sufficient stability of the dispersion. The molecular weight of the polyacids providing the polyanions preferably is 1,000 to 2,000,000, particularly preferably 2,000 to 500,000. The polyacids or their alkali salts are commonly available, e.g., polystyrenesulfonic acids and polyacrylic acids, or they may be produced based on known methods. Instead of the free acids required for the formation of the electrically conducting polymers and polyanions, mixtures of alkali salts of polyacids and appropriate amounts of monoacids may also be used.

While general synthesis procedures and compositions are described above, the polythiophene/polyanion compositions employed in the present invention are not new themselves, and are commercially available. Preferred electrically-conductive polythiophene/polyanion polymer compositions for use in the present invention include 3,4-dialkoxy substituted polythiophene/poly(styrene sulfonate), with the most preferred electrically-conductive polythiophene/polyanion polymer composition being poly(3,4-ethylene dioxythiophene)/poly(styrene sulfonate), which is available commercially from Bayer Corporation as Baytron P.

The other preferred electrically conductive polymers include poly(pyrrole styrene sulfonate) and poly(3,4-ethylene dioxypyrrole styrene sulfonate) as disclosed in U.S. Pat. Nos. 5,674,654; and 5,665,498; respectively.

Any polymeric film-forming binder, including water soluble polymers, synthetic latex polymers such as acrylics, styrenes, acrylonitriles, vinyl halides, butadienes, and others, or water dispersible condensation polymers such as polyurethanes, polyesters, polyester ionomers, polyamides, epoxides, and the like, may be optionally employed in the conductive layer to improve integrity of the conductive layer and to improve adhesion of the antistatic layer to an underlying and/or overlying layer. Preferred binders include polyester ionomers, vinylidene chloride containing interpolymers and sulfonated polyurethanes as disclosed in U.S. Pat. No. 6,124,083 incorporated herein by reference. The electrically-conductive polythiophene/polyanion composition to added binder weight ratio can vary from 100:0 to 0.1:99.9, preferably from 1:1 to 1:20, and more preferably from 1:2 to 1:20. The dry coverage of the electrically conductive substituted or unsubstituted thiophene-containing polymer employed depends on the inherent conductivity of the electrically-conductive polymer and the electrically-conductive polymer to binder weight ratio. A preferred range of dry coverage for the electrically-conductive substituted or unsubstituted thiophene-containing polymer component of the polythiophene/polyanion compositions is from about 0.5 mg/m.sup.2 to about 3.5 g/m.sup.2, this dry coverage should provide the desired electrical resistivity values while minimizing the impact of the electrically-conductive polymer on the color and optical properties of the article of the invention.

In addition to the electrically-conductive agent(s) and polymeric binder, the electrically-conductive materials useful in the invention may include crosslinking agents, organic polar solvents such as N-methylpyrrolidone, ethylene or diethylene glycol, and the like; coating aids and surfactants, dispersing aids, coalescing aids, biocides, matte particles, dyes, pigments, plasticizer, adhesion promoting agents, particularly those comprising silane and/or epoxy silane, waxes, and other lubricants. A common level of coating aid in the conductive coating formula, e.g., is 0.01 to 0.3 weight % active coating aid based on the total solution weight. These coating aids are typically either anionic or nonionic and can be chosen from many that are applied for aqueous coating. The various ingredients of the coating solution may benefit from pH adjustment prior to mixing, to insure compatibility. Commonly used agents for pH adjustment are ammonium hydroxide, sodium hydroxide, potassium hydroxide, tetraethyl amine, sulfuric acid, acetic acid, etc.

The electrically-conductive materials useful in the invention may be applied from either aqueous or organic solvent coating formulations using any of the known coating techniques such as roller coating, gravure coating, air knife coating, rod coating, extrusion coating, blade coating, curtain coating, slide coating, and the like. After coating, the layers are generally dried by simple evaporation, which can be accelerated by known techniques such as convection heating. Known coating and drying methods are described in further detail in Research Disclosure No. 308119, Published December 1989, pages 1007 to 1008. A preferred method for the coating of the electrically conductive materials into the conduits is roll coating of the sheet containing the conduits followed by removal of the conductive material located at the peaks of the conduits by a scraping blade or reverse roll contacting the peaks of the conduits.

Other conductive materials useful in this invention comprises a gelatin binder and a metallic salt. The gelatin binder has been shown to provide high visible light transparency, has excellent adhesion to the polymer conduits and contains moisture to aid in building a salt bridge between the particles of metallic salt. Examples of preferred metallic salts include sodium chloride, potassium iodide, calcium chloride, potassium bromide, sodium iodide, magnesium chloride, silver chloride and silver iodide. One interesting aspect of this particular embodiment is the humidity sensitivity of the gelatin. As ambient relative humidity moves below 50% the moisture content of the gelatin lowers and thus the resistivity of the conductive conduit increases creating a conductive circuit that is sensitivity to humidity. This particular embodiment would be useful as a humidity sensor that would control a system to add moisture to air as the humidity drops.

The desired resistivity of the conductive material is less than 5000 ohm meter. The preferred resistivity of the conductive materials is less than 1000 ohm meter, more preferred less than 600 ohm meter and most preferred between 0.01 and 300 ohm meter. In terms of SER of the conductive layer inside the conduit, the desired value is less than 5000 ohm/square, preferably less than 1000 ohm/square, more preferably less than 600 ohm/square and most preferably less than 300 ohm/square.

Because the conductive materials useful in the invention tend to have some level of coloration and thus transmitted light density, the lower levels of preferred resistivity will generally increase the density and thus lower the light transmission. For example the transmission difference between 1000 ohm meters and 100 ohm meters for polythiophene is approximately 5%. Higher levels of preferred resistivity are preferred for high transparency requirements or for low cost liquid crystal display applications where resistivity is not a primary concern for changing the orientation of the cholesteric liquid crystal. This is true for either transmissive or reflective display since light pass through these are either once or twice in the case of reflective displays. This invention is significantly advantaged over prior art patterned sheet in that the plurality of polymer conduits are integral to the polymer sheet. Integral polymer conduits tend to have the same materials composition as the sheet and there is no well defined boundary as one would expect when examining a coated structure. Integral conduit channels are advantaged over ultra violet coated and cured channels in that the conduits are integral, that is part of the polymer sheet rather than being applied to a polymer sheet, which creates unwanted interface issues such as delamination and cracking due to coefficient of thermal expansion differences between the channel materials and the sheet materials. Because the conductive materials do have some low level of resistivity, the energy lost will be transformed into heat energy subjecting the article of the invention to changes in temperature, compounded by extreme ambient changes in temperature (−20 degrees Celsius to 100 degrees Celsius) that can be expected. Integral conduits have the same thermal expansion coefficients and thus do not suffer from prior art interface issues, do not suffer from multiple optical surfaces which create unwanted Fresnel reflections and can be produced with high levels of precision.

The conductive materials contained in the conduits of the invention are preferably protected with an overcoat material. By protecting the conductive material in the conduit, scratching and delamination of the conductive material in the conduit is avoided to produce a rugged conductive sheet. Further, by protecting the conductive material in the conduit, a secondary coating surface, adjacent to the protective layer can be utilized for coatings or printing. Examples of coatings or printing include imaging layers, printed membrane circuit designs, coatings of cholesteric liquid crystal materials, and microlens arrays to manage the output of the transmitted light.

The protective overcoat layer preferably has a pencil hardness of greater than 2 H. A pencil hardness greater than 2 H resists many of the scratching forces caused during device assembly or actual use. Scratching of the overcoat layer will cause unwanted disruptions to the transmitted light and thus will reduce the optical utility of the invention. The protective overcoat preferably has a surface roughness less than 0.18 micrometers. Surface roughness greater than 0.20 micrometers has been shown to diffuse transmitted light and reduce the backlight intensity of membrane switches for example. Additionally, surface roughness less than 0.18 provides an excellent surface for auxiliary coatings or printing. The protective overcoat preferably has a resistivity greater than 5000 ohm meters. A resistivity greater than 5000 ohm meters provides sufficient electrical current flow resistance to prevent shorts in a circuit, current drain or unwanted electrical fields. The protective overcoat preferably has a surface energy less than 40 dynes/cm². By providing a surface energy less than 40 dynes/cm², water and other aqueous solvents which would change the resistivity of the conductive material form beads on the surface of the overcoat and can easily be removed. The protective overcoat layer may consist of suitable material that protects the image from environmental solvents, resists scratching, and does not interfere with the light transmission quality. The protective overcoat layer is preferably applied to the conducive material in either a uniform coating or a pattern wise coating. In a preferred embodiment of the invention the protective overcoat is applied in the presence of an electric field and fused to the topmost layer causing the transparent polymer particles to form a continuous polymeric layer is preferred. An electrophotographic toner applied polymer is preferred, as it is an effective way to provide a thin layer.

In another embodiment, the protective overcoat layer is coatable from aqueous solution and forms a continuous, water-impermeable protective layer in a post-process fusing step. The protective overcoat layer is preferably formed by coating polymer beads or particles of 0.1 to 50 μm in average size together with a polymer latex binder on the emulsion side of a sensitized photographic product. Optionally, a small amount of water-soluble coating aids (viscosifiers, surfactants) can be included in the layer, as long as they leach out of the coating during processing. After coating the sheet is treated in such a way as to cause fusing and coalescence of the coated polymer beads, by heat and/or pressure (fusing), solvent treatment, or other means so as to form the desired continuous, water impermeable protective layer.

Examples of suitable polymers from which the polymer particles used in protective overcoat layer can be selected include poly(vinyl chloride), poly(vinylidene chloride), poly(vinyl chloride-co-vinylidene chloride), chlorinated polypropylene, poly(vinyl chloride-co-vinyl acetate), poly(vinyl chloride-co-vinyl acetate-co-maleic anhydride), ethyl cellulose, nitrocellulose, poly(acrylic acid) esters, linseed oil-modified alkyd resins, rosin-modified alkyd resins, phenol-modified alkyd resins, phenolic resins, polyesters, poly(vinyl butyral), polyisocyanate resins, polyurethanes, poly(vinyl acetate), polyamides, chroman resins, dammar gum, ketone resins, maleic acid resins, vinyl polymers, such as polystyrene and polyvinyltoluene or copolymer of vinyl polymers with methacrylates or acrylates, poly(tetrafluoroethylene-hexafluoropropylene), low-molecular weight polyethylene, phenol-modified pentaerythritol esters, poly(styrene-co-indene-co-acrylonitrile), poly(styrene-co-indene), poly(styrene-co-acrylonitrile), poly(styrene-co-butadiene), poly(stearyl methacrylate) blended with poly(methyl methacrylate), copolymers with siloxanes and polyalkenes. These polymers can be used either alone or in combination. In a preferred embodiment of the invention, the polymer comprises a polyester or poly(styrene-co-butyl acrylate). Preferred polyesters are based on ethoxylated and/or propoxylated bisphenol A and one or more of terephthalic acid, dodecenylsuccinic acid and fumaric acid as they form an acceptable protective overcoat layer that generally survives the rigors of a packaging label.

To increase the abrasion resistance of the protective overcoat layer, polymers which are cross-linked or branched can be used. For example, poly(styrene-co-indene-co-divinylbenzene), poly(styrene-co-acrylonitrile-co-divinylbenzene), or poly(styrene-co-butadiene-co-divinylbenzene) can be used.

The polymer particles for the protective overcoat layer should be transparent, and are preferably colorless. But it is specifically contemplated that the polymer particle can have some color for the purposes of color correction, or for special effects. Thus, there can be incorporated into the polymer particle dye which will impart color. In addition, additives can be incorporated into the polymer particle which will give to the overcoat desired properties. For example, a UV absorber can be incorporated into the polymer particle to make the overcoat UV absorptive, thus protecting the sheet from UV induced fading or blue tint can be incorporated into the polymer particle to offset the native yellowness of the gelatin used in the gelatin salt conductive material.

In addition to the polymer particles which form the protective overcoat layer, there can be combined with the polymer composition other particles which will modify the surface characteristics of the element. Such particle are solid and nonfusible at the conditions under which the polymer particles are fused, and include inorganic particles, like silica, and organic particles, like methylmethacrylate beads, which will not melt during the fusing step and which will impart surface roughness to the overcoat.

The surface characteristics of the protective overcoat layer are in large part dependent upon the physical characteristics of the polymer which forms the toner and the presence or absence of solid, nonfusible particles. However, the surface characteristics of the overcoat also can be modified by the conditions under which the surface is fused. For example, the surface characteristics of the fusing member that is used to fuse the toner to form the continuous overcoat layer can be selected to impart a desired degree of smoothness, texture or pattern to the surface of the element. Thus, a highly smooth fusing member will give a glossy surface to the imaged element, a textured fusing member will give a matte or otherwise textured surface to the element, a patterned fusing member will apply a pattern to the surface of the article.

Suitable examples of the polymer latex binder include a latex copolymer of butyl acrylate, 2-acrylamido-2-methylpropanesulfonate, and acetoacetoxyethylmethacrylate. Other latex polymers which are useful include polymers having a 20 to 10,000 nm diameter and a Tg of less than 60° C. suspended in water as a colloidal suspension.

Examples of suitable coating aids for the protective overcoat layer include any water soluble polymer or other material that imparts appreciable viscosity to the coating suspension, such as high MW polysaccharide derivatives (e.g. xanthan gum, guar gum, gum acacia, Keltrol (an anionic polysaccharide supplied by Merck and Co., Inc.) high MW polyvinyl alcohol, carboxymethylcellulose, hydroxyethylcellulose, polyacrylic acid and its salts, polyacrylamide, etc). Surfactants include any surface active material that will lower the surface tension of the coating preparation sufficiently to prevent edge-withdrawal, repellencies, and other coating defects. These include alkyloxy- or alkylphenoxypolyether or polyglycidol derivatives and their sulfates, such as nonylphenoxypoly(glycidol) available from Olin Matheson Corporation or sodium octylphenoxypoly(ethyleneoxide) sulfate, organic sulfates or sulfonates, such as sodium dodecyl sulfate, sodium dodecyl sulfonate, sodium bis(2-ethylhexyl)sulfosuccinate (Aerosol OT), and alkylcarboxylate salts such as sodium decanoate.

In another embodiment, the application of an ultraviolet polymerizable monomers and oligomers to the conductive materials is preferred. UV cure polymers are preferred, as they can easily be applied to the conductive material in both a uniform coating or a patterned coating. Preferred UV cure polymers include aliphatic urethane, allyl methacrylate, ethylene glycol dimethacrylate, polyisocyanate and hydroxyethyl methacrylate. A preferred photoinitiator is benzil dimethyl ketal. The preferred intensity of radiation is between 0.1 and 1.5 milliwatt/cm². Below 0.05, insufficient cross-linking occurs yielding a protective layer that does not offer sufficient protection for the protection of the conductive materials.

In another embodiment of the invention, the application of a pre-formed polymer layer to the outermost surface of the conduits form an protective overcoat layer is most preferred. Application of a pre-formed sheet is preferred because pre-formed sheets are tough and durable easily withstanding the environmental solvents and handling forces. Application of the pre-formed polymer sheet is preferable carried out though lamination after image development. An adhesive is applied to either the photographic label or the pre-formed polymer sheet prior to a pressure nip that adheres the two surfaces and eliminates any trapped air that would degrade the quality of the transmitted light.

The pre-formed sheet preferably is an oriented polymer because of the strength and toughness developed in the orientation process. Preferred polymers for the flexible substrate include polyolefins, polyester and nylon. Preferred polyolefins include polypropylene, polyethylene, polymethylpentene, polystyrene, polybutylene, and mixtures thereof. Polyolefin copolymers, including copolymers of propylene and ethylene such as hexene, butene, and octene are also useful. Polypropylene is most preferred, as it is low in cost and has desirable strength and toughness properties required for a pressure sensitive label.

In another embodiment, the application of a synthetic latex to the conductive materials to form a protective overcoat layer is preferred. A coating of synthetic latex has been shown to provide an acceptable protective overcoat layer and can be coated in an aqueous solution eliminating exposure to solvents. The coating of latex has been shown to provide an acceptable protective overcoat layer for conductive circuits. Preferred synthetic latexes for the protective overcoat layer are made by emulsion polymerization techniques from styrene butadiene copolymer, acrylate resins, and polyvinyl acetate. The preferred particles size for the synthetic latex ranges from 0.05 to 0.15 μm. The synthetic latex is applied to the outermost layer of the silver halide imaging layers by known coating methods that include rod coating, roll coating and hopper coating. The synthetic latexes must be dried after application and must dry transparent so as not to interfere with the quality of the transmitted light energy.

In a preferred embodiment, the conductive material comprises a pigment or dye. Pigments or dye provide coloration to the conductive material creating contrast difference between the insulating areas of the article and the conductive materials. Increasing the transmitted light contrast with a white pigment or carbon black provides allows for a higher contrast image or the ability to lower the illuminant output.

The article of the invention preferably has a light transmission greater than 75% or more preferably a light transmission greater than 90%. By providing high light transmission, the article of the invention can be utilized as a display such as a membrane switch or a radio frequency antenna without the conductive materials obstructing the visible light.

The conduits of the invention preferably comprise thermoplastic polymers. Thermoplastic polymers are preferred as they are generally lower in cost compared to prior art glass, have excellent optical properties and can be efficiently formed into sheets utilizing an extrusion roll molding process were melted polymer is cast against a patterned precision roll forming integral conduits. Preferred polymers for the formation of the complex lenses include polyolefins, polyesters, polyamides, polycarbonates, cellulosic esters, polystyrene, polyvinyl resins, polysulfonamides, polyethers, polyimides, polyvinylidene fluoride, polyurethanes, polyphenylenesulfides, polytetrafluoroethylene, polyacetals, polylatic acid, liquid crystal polymers, cyclo-olefins, polysulfonates, polyester ionomers, and polyolefin ionomers. Copolymers and/or mixtures of these polymers to improve mechanical or optical properties can be used. Preferred polyamides for the transparent complex lenses include nylon 6, nylon 66, and mixtures thereof. Copolymers of polyamides are also suitable continuous phase polymers. An example of a useful polycarbonate is bisphenol-A polycarbonate. Cellulosic esters suitable for use as the continuous phase polymer of the complex lenses include cellulose nitrate, cellulose triacetate, cellulose diacetate, cellulose acetate propionate, cellulose acetate butyrate, and mixtures or copolymers thereof. Preferred polyvinyl resins include polyvinyl chloride, poly(vinyl acetal), and mixtures thereof. Copolymers of vinyl resins can also be utilized. Preferred polyesters for the complex lens of the invention include those produced from aromatic, aliphatic or cycloaliphatic dicarboxylic acids of 4-20 carbon atoms and aliphatic or alicyclic glycols having from 2-24 carbon atoms. Examples of suitable dicarboxylic acids include terephthalic, isophthalic, phthalic, naphthalene dicarboxylic acid, succinic, glutaric, adipic, azelaic, sebacic, fumaric, maleic, itaconic, 1,4-cyclohexanedicarboxylic, sodiosulfoisophthalic and mixtures thereof. Examples of suitable glycols include ethylene glycol, propylene glycol, butanediol, pentanediol, hexanediol, 1,4-cyclohexanedimethanol, diethylene glycol, other polyethylene glycols and mixtures thereof.

The depth of the conduits, measured from the surface of the top of the conduit on the outermost layer o the conductive sheet preferably has a depth of between 0.1 and 100 micrometers, more preferably between 0.1 and 10 micrometers. It has been found that the depth of the channels should roughly equal the thickness of the conductive material plus the thickness of the protective layer. Most contemplated combination of conductive material thickness added to overcoat layer thickness are between 0.10 and 100 micrometers and are optimized for electrical conductivity between 1 and 8 micrometers. The preferred thickness of the sheet is between 20 and 300 micrometers. Below 15 micrometers, the conduits are difficult to form and coat with the conductive materials. Above 300 micrometers, the additional thickness is not cost justified.

The roughness average of the top of said polymer conduits is between 0.25 and 2.5 micrometers. By providing a rough surface to the top conduit, a stand off layer is created for the lamination of an oriented polymer sheet. In another embodiment, the roughness average of the top of the polymer conduits is less than 0.20 micrometers. By providing a smooth conduit surface, auxiliary coating can be added without creating light diffusion in transmission.

The surface roughness of the bottom of the conduits preferably is between 0.25 and 2.5 micrometers. By providing a bottom surface roughness in this range, the amount of surface area is increased compared to a smooth bottom surface which increases the amount of electrical conductivity. Further, by providing a rough bottom surface, the adhesion of the conductive material to the conduit polymer is improved thereby improving the reliability of the conductive conduit as disruption in the coating would result in resistivity greater than 5000 ohm meters. In another embodiment, the bottom surface in the conduit has a surface roughness less than 0.20 micrometers. By providing a smooth bottom surface, transmitted light is less likely to be diffused, improving the contrast of printed layers or imaged layers.

In another preferred embodiment of the invention, the polymer layer further comprises a pressure sensitive adhesive. A pressure sensitive adhesive allows the article of the invention to be positioned on other substrates or devices. An example is adhering the article of the invention to as glass substrate for use as a display device or adhering the article of the invention to a printed circuit board. The pressure sensitive comprises adhesives that are known in the art to be transparent and have a high bond strength. Examples include acrylic and urethane based pressure sensitive adhesive systems.

The plurality of conduits preferably have at least one intersection point. By providing at least one intersection point, the conductive conduits of the invention can power by a single power source such as a DC source, and an be terminated at some logical point such as an IC chip, resistor, capacitor, transistor or electrical ground. In another preferred embodiment of the invention, the plurality of conduits have at least one direction change relative to the conduit starting direction. A direction change of greater than 30 degrees allows the conductive conduits of the invention to be better utilized as connections for an electrical circuit. An example of a direction change greater than 30 degrees would be the electrical connections in a membrane switch. In a membrane switch, the conductive membrane, upon depression, completes an electrical circuit that communicates switch logic with an auxiliary device such as an IC chip. Conductive conduits that change direction are better able to be positioned around the membrane switch contact area often requiring several direction changes to accommodate the layout of the switch.

In order to improve the impact strength of the polymer conduits and improve the temperature resistance of the polymers conduits, nanocomposite addition to the polymer conduits is preferred. Nanocomposite materials have been shown to improve the thermal properties of conduit polymer and increase the mechanical modulus, thus, making them more suitable for polymer circuits and display devices.

“Nanocomposite” shall mean a composite material wherein at least one component comprises an inorganic phase, such as a smectite clay, with at least one dimension in the 0.1 to 100 nanometer range. “Plates” shall mean particles with two dimensions of the same size scale and is significantly greater than the third dimension. Here, length and width of the particle are of comparable size but orders of magnitude greater than the thickness of the particle.

“Layered material” shall mean an inorganic material such as a smectite clay that is in the form of a plurality of adjacent bound layers. “Platelets” shall mean individual layers of the layered material. “Intercalation” shall mean the insertion of one or more foreign molecules or parts of foreign molecules between platelets of the layered material, usually detected by X-ray diffraction technique, as illustrated in U.S. Pat. No. 5,891,611 (line 10, col. 5-line 23, col. 7).

“Intercalant” shall mean the aforesaid foreign molecule inserted between platelets of the aforesaid layered material. “Exfoliation” or “delamination” shall mean separation of individual platelets in to a disordered structure without any stacking order. “Intercalated” shall refer to layered material that has at least partially undergone intercalation and/or exfoliation. “Organoclay” shall mean clay material modified by organic molecules.

The layered materials for this invention can comprise any inorganic phase desirably comprising layered materials in the shape of plates with significantly high aspect ratio. However, other shapes with high aspect ratio will also be advantageous, as per the invention. The layered materials preferred for this invention include phyllosilicates, e.g., montmorillonite, particularly sodium montmorillonite, magnesium montmorillonite, and/or calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof. Other useful layered materials include illite, mixed layered illite/smectite minerals, such as ledikite and admixtures of illites with the clay minerals named above. Other useful layered materials, particularly useful with anionic matrix polymers, are the layered double hydroxides or hydrotalcites, such as Mg₆Al_{3.4}(OH)_{18.8}(CO₃)_{1.7}H₂O, which have positively charged layers and exchangeable anions in the interlayer spaces. Other layered materials having little or no charge on the layers may be useful provided they can be intercalated with swelling agents, which expand their interlayer spacing. Such materials include chlorides such as FeCl₃, FeOCl, chalcogenides, such as TiS₂, MoS₂, and MoS₃, cyanides such as Ni(CN)₂ and oxides such as H₂Si₂O₅, V₆O₁₃, HtiNbO₅, Cr_{0.5}V_{0.5}S₂, V₂O₅, Ag doped V₂O₅, W_{0.2}V_{2.8}O7, Cr₃O₈, MoO₃(OH)₂, VOPO₄-2H₂O, CaPO₄CH₃—H₂O, MnHASO₄—H₂O, Ag₆Mo₁₀O₃₃ and the like. Preferred layered materials are swellable so that other agents, usually organic ions or molecules, can intercalate and/or exfoliate the layered material resulting in a desirable dispersion of the inorganic phase. These swellable layered materials include phyllosilicates of the 2:1 type, as defined in clay literature (vide, for example, “An introduction to clay colloid chemistry,” by H. van Olphen, John Wiley & Sons Publishers). Typical phyllosilicates with ion exchange capacity of 50 to 300 milliequivalents per 100 grams are preferred. Preferred layered materials for the present invention include smectite clay such as montmorillonite, nontronite, beidellite, volkonskoite, hectorite, saponite, sauconite, sobockite, stevensite, svinfordite, halloysite, magadiite, kenyaite and vermiculite as well as layered double hydroxides or hydrotalcites. Most preferred smectite clays include montmorillonite, hectorite and hydrotalcites, because of commercial availability of these materials.

The aforementioned smectite clay can be natural or synthetic. This distinction can influence the particle size and/or the level of associated impurities. Typically, synthetic clays are smaller in lateral dimension, and therefore possess smaller aspect ratio. However, synthetic clays are purer and are of narrower size distribution, compared to natural clays and may not require any further purification or separation. For this invention, the smectite clay particles should have a lateral dimension of between 0.01 μm and 5 μm, and preferably between 0.05 μm and 2 μm, and more preferably between 0.1 μm and 1 μm. The thickness or the vertical dimension of the clay particles can vary between 0.5 nm and 10 nm, and preferably between 1 nm and 5 nm. The aspect ratio, which is the ratio of the largest and smallest dimension of the clay particles should be between 10:1 and 1000:1 for this invention. The aforementioned limits regarding the size and shape of the particles are to ensure adequate improvements in some properties of the nanocomposites without deleteriously affecting others. For example, a large lateral dimension may result in an increase in the aspect ratio, a desirable criterion for improvement in mechanical and barrier properties. However, very large particles can cause optical defects due to deleterious light scattering, and can be abrasive to processing, conveyance and finishing equipment as well as to other components.

The concentration of smectite clay in the optical component of the invention can vary as per need; however, it is preferred to be <10% by weight of the binder. Significantly higher amounts of clay can impair physical properties of the optical component by rendering it brittle, as well as difficult to process. On the other hand, too low a concentration of clay may fail to achieve the desired optical effect. It is preferred that the clay concentration be maintained between 1 and 10% and more preferred to be between 1.5 and 5% for optimum results.

The smectite clay materials, generally require treatment by one or more intercalants to provide the required interlayer swelling and/or compatibility with the matrix polymer. The resulting interlayer spacing is critical to the performance of the intercalated layered material in the practice of this invention. As used herein the “inter-layer spacing” refers to the distance between the faces of the layers as they are assembled in the intercalated material before any delamination (or exfoliation) takes place. The preferred intercalants include organic and polymeric materials, particularly block copolymers as disclosed in dockets 82056; 82,857; 82858 and 82,859; incorporated herein by reference. Examples of such intercalants include ethoxylated alcohols, polyether block polyamide, poly(ethylene oxide-b-caprolactone) and the like. These preferred intercalants can be incorporated in natural or synthetic clay. These preferred intercalants can also be incorporated in organoclays, which have already been modified by organic molecule(s).

In a preferred embodiment of this invention the article comprising a layer or sheet of nonconductive polymeric material comprising a plurality of patterned integral conduit channels containing a conductive material. The conduit channels may comprise trenches, furrows or grooves in the surface of the polymeric material. The conduits may have a depth of between 0.1 and 100 micrometers for electromodulating displays or TFT's.

Other Uses

The article of the invention may also be used in conjunction with a light diffuser, for example a bulk diffuser, a lenticular layer, a beaded layer, a surface diffuser, a holographic diffuser, a micro-structured diffuser, another lens array, or various combinations thereof. A diffuser film disperses, or diffuses, the light, thus destroying any diffraction pattern that may arise from the addition of an ordered periodic lens array.

The article of the present invention may be used in combination with a film or sheet made of a transparent or opaque polymer. In reflective display having an opaque polymer provides enhanced contrast. Examples of such polymer are polyesters such as polycarbonate, polyethylene terephthalate, polybutylene terephthalate and polyethylene naphthalate, acrylic polymers such as polymethyl methacrylate, and polyethylene, polypropylene, polystyrene, polyvinyl chloride, polyether sulfone, polysulfone, polyacrylate and triacetyl cellulose. The transparent polymeric film of the invention can also include, in another aspect, one or more optical coatings to improve optical transmission through one or more conduits. It is often desirable to coat a diffuser with a layer of an anti-reflective (AR) coating in order to raise the efficiency of the article.

The article of the present invention may be incorporated with e.g. an additive or a lubricant such as silica for improving the surface-slipperiness of the film within a range not to deteriorate the optical characteristics to vary the light-scattering property with an incident angle. Examples of such additive are organic solvents such as xylene, alcohols or ketones, fine particles of an acrylic resin, silicone resin or Δ metal oxide or a filler.

The article of the present invention usually has optical anisotropy. The polymer sheet containing thermoplastic conduits are generally optically anisotropic materials exhibiting optical anisotropy having an optic axis in the drawing direction. The optical anisotropy is expressed by the product of the film thickness d and the birefringence Δn which is a difference between the refractive index in the slow optic axis direction and the refractive index in the fast optic axis direction in the plane of the film, i.e. Δn*d (retardation). The orientation direction coincides with the drawing axis in the film of the present invention. The drawing axis is the direction of the slow optic axis in the case of a thermoplastic polymer having a positive intrinsic birefringence and is the direction of the fast optic axis for a thermoplastic polymer having a negative intrinsic birefringence. There is no definite requirement for the necessary level of the value of Δn.*d since the level depends upon the application of the film.

In the manufacturing process for this invention, preferred conduit polymers are melt extruded from a slit die. In general, a T die or a coat hanger die are preferably used. The process involves extruding the polymer or polymer blend through a slit die and rapidly quenching the extruded web upon a chilled casting drum with the preferred conduit geometry so that the conduit polymer component of the transparent sheet are quenched below their glass solidification temperature and retain the shape of the desired conduits.

A method of fabricating the polymer conduits was developed. The preferred approach comprises the steps of providing a positive master extrusion roll having a plurality of conduits. The sheet is replicated from the master extrusion roller by casting the desired molten polymeric material to the face of the extrusion roll, cooling the desired polymer below the Tg of the polymer and then striping the polymer sheet containing the conduits from the extrusion roll. The patterned roll is created by machine the negative of the pattern into the roller utilizing precision machine techniques such as ion beam milling r diamond turning. The negative of the desired conduit pattern may also be machined into a thin metallic sheet and then wrapped around a roller. The conduits of the invention may also be created by hot embossing, UV cure polymers, vacuum forming or injection molding.

The invention may be used in conjunction with any liquid crystal display devices, typical arrangements of which are described in the following. Liquid crystals (LC) are widely used for electronic displays. In these display systems, an LC layer is situated between a polarizer layer and an analyzer layer and has a director exhibiting an azimuthal twist through the layer with respect to the normal axis. The analyzer is oriented such that its absorbing axis is perpendicular to that of the polarizer. Incident light polarized by the polarizer passes through a liquid crystal cell is affected by the molecular orientation in the liquid crystal, which can be altered by the application of a voltage across the cell. By employing this principle, the transmission of light from an external source, including ambient light, can be controlled. The energy required to achieve this control is generally much less than that required for the luminescent materials used in other display types such as cathode ray tubes. Accordingly, LC technology is used for a number of applications, including but not limited to digital watches, calculators, portable computers, electronic games for which light weight, low power consumption and long operating life are important features.

Active-matrix liquid crystal displays (LCDs) use thin film transistors (TFTs) as a switching device for driving each liquid crystal pixel. These LCDs can display higher-definition images without cross talk because the individual liquid crystal pixels can be selectively driven. Optical mode interference (OMI) displays are liquid crystal displays, which are “normally white,” that is, light is transmitted through the display layers in the off state. Operational mode of LCD using the twisted nematic liquid crystal is roughly divided into a birefringence mode and an optical rotatory mode. “Film-compensated super-twisted nematic” (FSTN) LCDs are normally black, that is, light transmission is inhibited in the off state when no voltage is applied. OMI displays reportedly have faster response times and a broader operational temperature range.

Ordinary light from an incandescent bulb or from the sun is randomly polarized, that is, it includes waves that are oriented in all possible directions. A polarizer is a dichroic material that functions to convert a randomly polarized (“unpolarized”) beam of light into a polarized one by selective removal of one of the two perpendicular plane-polarized components from the incident light beam. Linear polarizers are a key component of liquid-crystal display (LCD) devices.

There are several types of high dichroic ratio polarizers possessing sufficient optical performance for use in LCD devices. These polarizers are made of thin sheets of materials which transmit one polarization component and absorb the other mutually orthogonal component (this effect is known as dichroism). The most commonly used plastic sheet polarizers are composed of a thin, uniaxially-stretched polyvinyl alcohol (PVA) film which aligns the PVA polymer chains in a more-or-less parallel fashion. The aligned PVA is then doped with iodine molecules or a combination of colored dichroic dyes (see, for example, EP 0 182 632 A2, Sumitomo Chemical Company, Limited) which adsorb to and become uniaxially oriented by the PVA to produce a highly anisotropic matrix with a neutral gray coloration. To mechanically support the fragile PVA film it is then laminated on both sides with stiff layers of triacetyl cellulose (TAC), or similar support.

Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cell, which are in the dark or “black” pixel state. Furthermore, the leakage and hence contrast of a liquid crystal display are also dependent on the angle from which the display screen is viewed. Typically the optimum contrast is observed only within a narrow viewing angle centered about the normal incidence to the display and falls off rapidly as the viewing angle is increased. In color displays, the leakage problem not only degrades the contrast but also causes color or hue shifts with an associated degradation of color reproduction. In addition to black-state light leakage, the narrow viewing angle problem in typical twisted nematic liquid crystal displays is exacerbated by a shift in the brightness-voltage curve as a function of viewing angle because of the optical anisotropy of the liquid crystal material.

The article of the invention was measured for transmission with the Hitachi U4001 UV/Vis/NIR spectrophotometer equipped with an integrating sphere. The total transmittance spectra were measured by placing the samples at the beam port with the front surface with conduits towards the integrating sphere. A calibrated 99% diffusely reflecting standard (NIST-traceable) was placed at the normal sample port. The diffuse transmittance spectra were measured in like manner, but with the 99% tile removed. The diffuse reflectance spectra were measured by placing the samples at the sample port with the coated side towards the integrating sphere. In order to exclude reflection from a sample backing, nothing was placed behind the sample. All spectra were acquired between 350 and 800 nm. As the diffuse reflectance results are quoted with respect to the 99% tile, the values are not absolute, but would need to be corrected by the calibration report of the 99% tile.

Percentage total transmitted light refers to percent of light that is transmitted though the sample at all angles. Diffuse transmittance is defined as the percent of light passing though the sample excluding a 2.5 degree angle from the incident light angle. The diffuse light transmission is the percent of light that is passed through the sample by diffuse transmittance. Diffuse reflectance is defined as the percent of light reflected by the sample. The percentages quoted in the examples were measured at 500 nm. These values may not add up to 100% due to absorbencies of the sample or slight variations in the sample measured. Embodiments of the invention may provide not only improved light diffusion and transmission but also a diffusion film of reduced thickness, and that has reduced light scattering tendencies.

### EXAMPLES

In this example, polycarbonate V shaped conduits were formed integral to a polycarbonate 100 micrometer sheet. A conductive, transparent form of polythiophene was applied into the V shaped conduits creating a transparent conductive sheet. This invention will demonstrate the conductive and transmissive properties of the polymer sheet containing the conductive, transparent polymer.

The V shaped conduits were made by casting melted polcarbonate against a heated roller containing the negative of the V groove pattern. The V-groove patterned roller was manufactured by precision machining, utilizing a wire EDM cutting tool, the negative of the V groove pattern into the surface of a smooth steel roller.

The V groove patterned roller was used to create the integral polycarbonate conduits by extrusion casting a polycarbonate polymer from a coat hanger slot die comprising substantially 98.0% 68 melt index CD grade polycarbonate (Bayer Chemical), 1.5% antioxidant and 0.5% release agent on to the heated V grove patterned roller (120 degrees C.), cooling the polycarbonate below the Tg of the polycarbonate and striping the polycarbonate web containing the V grove shaped conduits from the heated roller. The thickness of the polymer sheet containing the V-grooves was 100 micrometers. The V grooves were 10 micrometers deep with a 1 micrometer flat at the bottom of the V groove with a pitch of 200 micrometers. There were 20 conduits counted in a direction perpendicular to the primary direction of the conduits. All 20 conduits were roughly equidistant from each other along the 30 cm length of the conduits. The structure of the cast coated light diffusion sheets of the invention was as follows,

Formed integral polycarbonate V grooves

Transparent polycarbonate base

After formation of the polycarbonate sheet containing the V groove shaped conduits, the sheet was subjected to corona discharge treatment and coated with a conductive coating composition by hopper coating. The conductive coating composition comprised of Baytron P, a commercially available poly (3,4 ethylenedioxythiophene) poly(styrenesulfonate) aqueous dispersion, supplied by Bayer corporation, and other addenda including surfactant, and organic polar solvents. Immediately upon coating, the polycarbonate sheet was carefully wiped off with a wet piece of lint-free cloth so that only the grooves retained the coating composition, which was allowed to dry there. The nominal dry coverage of the transparent, electronically conductive poly (3,4 ethylenedioxythiophene) poly(styrenesulfonate) within the groove was estimated to be 0.33 g/M².

The resistivity of the conductive conduits was measured using a FLUKE model 300 multimeter which is a two probe contact method of measuring resistivity. Each conductive conduit was measured for resisitivity and the average and range for each of 20 conductive conduits was determined. The average SER of such a conductive transparent layer is 880 ohms/square with a standard deviation of 138 ohms/square.

The polycarbonate sheet containing the conductive, transparent V shaped conduits were measured for % light transmission, % diffuse light transmission, % specular light transmission and % diffuse reflectance and conductivity.

The conductive sheet was measured with the Hitachi U4001 UV/Vis/NIR spectrophotometer equipped with an integrating sphere. The total transmittance spectra were measured by placing the samples at the beam port with the front surface with complex lenses towards the integrating sphere. A calibrated 99% diffusely reflecting standard (NIST-traceable) was placed at the normal sample port. The diffuse transmittance spectra were measured in like manner, but with the 99% tile removed. The diffuse reflectance spectra were measured by placing the samples at the sample port with the coated side towards the integrating sphere. In order to exclude reflection from a sample backing, nothing was placed behind the sample. All spectra were acquired between 350 and 800 nm. As the diffuse reflectance results are quoted with respect to the 99% tile, the values are not absolute, but would need to be corrected by the calibration report of the 99% tile.

Percentage total transmitted light refers to percent of light that is transmitted though the sample at all angles. Diffuse transmittance is defined as the percent of light passing though the sample excluding a 2 degree angle from the incident light angle. The diffuse light transmission is the percent of light that is passed through the sample by diffuse transmittance. Diffuse reflectance is defined as the percent of light reflected by the sample. The percentages quoted in the examples were measured at 500 nm. These values may not add up to 100% due to absorbencies of the sample or slight variations in the sample measured. The Total transmission was 90.1%, the diffuse transmission was 10.8%, the specular transmission was 82.4% and the diffuser reflection was 6.1%.

The data above clearly demonstrates both the electrical and optical utility of the invention. The conductive material applied to the V shaped conduits having an average SER of 880 ohms/square provides excellent electrical conductivity while simultaneously providing an excellent light transmission of 90.1%. This allows the invention material to be particularly useful in electrical application that require both conductivity and transparency such as a membrane switch for an appliance or a security card containing a smart chip. Further, the conduits of the invention provide protection to the delicate conductive polymer improving the reliability of the conductive channel by significantly reducing the disruption of the conductive pattern by scratching or abrasion. Additionally, the geometry of the conduits also allows for the addition of a protective layer further protecting the delicate conductive materials.

### Example 2

This Example is Both in Past and Present Tense, Revise

An electromodulating display cell was formed by extrusion roll molding a V-groove pattern in a sheet of polycarbonate as describe in the above example. The V-groove was further made conductive as per the above example. The sample was then spun coated with an organic resin solution that was a negative photo-resist. It should be noted that an area of the V-groove needs to be left uncoated on at least 2 sides for electrical connections. This is needed so the electrode formed by the V-groove with the conductive material can be switch from positive to negative or off. The material is SU-8 2010 series (Y111058) manufactured by MicroChem. A layer of approximately 10 micron is spun coated at 3000 PRM.

The sample is prebaked for approximately 3 minutes at an elevated temperature of approximately 65° C. A photo mask is prepared separately using Kodak Direct Image Setting Film (available from Eastman Kodak Company) and laser writing a cell pattern in which the wall areas for the micro-cell walls are clear on the mask film. The mask is placed over the top of the spun photo-resist and exposed using UV light for 120 seconds. The sample is then posted baked for 3 minutes. The sample is then developed using MicroChem SU 8 Developer (Y020100) for 2 minutes The sample is then rinsed for 30 seconds using isopropanol and air dried. When completed there is a wall structure of microcells that is capable of containing liquid. The depth is approximately 10 microns and the cells wall is approximately 20 microns wide.

An electrophoretic dispersion was prepared by mixing milled particles of electrically conductive carbon black (Regal 330 by Cabot) with a nominal particle size 80-100 nm in isopar L (Mobil Chemical) at approximately 2% by weight The cell-containing sheet with the conductive V-groove is then filled with the carbon black dispersion by apply an excess amount to the cells and using a blade to level and fill the cells. A top cover sheet of polycarbonate with a thermal adhesive is laminated to the cell sheet.

The filled cell sheet is connected to an electrcial function generator and a voltage of 40 volts apply across the V-groove electrode. The cell is placed under a microscope and the particles are observed as a positive voltage and then a negative voltage is applied across the V-groove electrode. The results from this example showed that the negative carbon black particles move towards the positive voltage of the electrode and move away from the electrode when the voltage is negative.

### Example 3

This example is another electromodulating display. A polycarbonate sheet with multiple pixels is prepared to look like FIG. 6. A polycarbonate sheet is grooved to form a trenches in the polymer sheet 121 that correspond to flag electrode bus-bar 123A that feeds flag electrode 125, collector electrode bus-bar 127 that feeds collector electrode 129, gate electrode bus-bar 131 that feeds gate electrode 135 and helper bus-bar electrode 137 that feeds helper electrode 139. The V-groove trenches formed are approximately 10 to 15 microns deep. The flag electrode bus-bars trenches (123A), gate bus-bar electrode trenches 131, collector electrode bus-bar trenches 127 and helper bus-bar electrode trenches 137 is patterned coated with a nano gold particle with a mean particle of approximately 5 nm. The gold particles were than sintered with a laser to form a continuous network of conducting metal in the trenches. The metal thickness in the trenches is less than 5 microns in thickness. A dielectric material is than patterned applied in the V-grooved trenches at the points where the bus-bar electrodes crossed over with helper electrode 139, collector electrode 129 and gate electrode 135. A second conductor then applied to complete these electrodes. The flag electrodes 125 is pattern printed with an electrically conductive polythiophene. Once all the electrodes were in placed, a network of cells walls 141 is made by coating the patterned sheet with negative photoresist SU8 (available from MicroChem) in a similar manner as described in example 2. The only difference is that the SU8 is diluted 50/50 with Micro-Chem's NANO Su-8 2000 thinner with a slot hopper to a thickness of 10 microns. The layer is allowed to dry in the dark for several hours at 45 C. The wall pattern is photo exposed, cured washed as per example 2. The cell network is filled and sealed with the same electromodulating material. The electrodes are hooked up to a frequency driver and a voltage applied. The electrodmodulating material is observed as the voltage polarity is switched. The observation is that the particles moved back and forth within the cells.

The invention has been described in detail with particular reference to certain preferred embodiments thereof, but it will be understood that variations and modifications can be effected within the scope of the invention.

### PARTS LIST

2 transparent polymer base sheet
4 transparent conductive material
6 transparent protective material
8 second conductive material
11 A,B,C,D micro-cell wails capable of holding electromodulating fluids
13 collector electrode
15 gate electrode
17 flag electrode
19 busbar
21 helper electrode
23 display pixel
31 electrode
33 electrode
35 crossover region
39 dielectric
41 Substrate surface
43 electrode
45 electrode
47 support with trench
51 perspective view of an electrode
53 perspective view of an electrode
55 dielectric separating electrodes 51 and 53
80 cross-sectional view of a display pixel
81 trenched polymer sheet
83 bus-bar electrode
85A,B,C dielectric regions
87 collector electrode
89 gate electrode
91 view or flag electrode
93 helper electrode on the surface of trenched polymer sheet 81.
95A, B, C vias that have been filled with a conductive material
97 wall on top of the polymer sheet (2D view of a cell)
99 electrodmodulating fluid 99.
101 polymer sheet
103 adhesive layer
111 polymeric substrate with formed trenches in an x,y plane consists of electrode 1 comprised of sections 113A,B,C
113A,B,C sections of electrode 1
115 Dielectric material
117 electrode 2 that runs in direction other than electrode 1.
119 air space
121 trenched polymer sheet
123A flag electrode bus-bar
125 flag electrode
127 collector electrode bus-bar
129 collector electrode,
131 gate electrode bus-bar
135 gate electrode
137 helper electrode busbar
139 helper electrode
141 network of cell walls that contain an elecrtomodulating fluid
140 electrowetting cell with two non-miscible fluids
141 wall structure
143 and 145 two non-miscible fluids in the cell.
147 trenched polymer sheet
151 hydrophobic insulator
145A non-miscible fluid shifted by an electric field
149 electrode in the base of the trench
153 electrodes/voltage source
161 column electrode
163 grooved polymer sheet
165 row electrode
167A medium that can be shifted in response to an electric field
167B medium that can be shifted in response to an electric field
169 switch
171 device for applying an electric field
175 wall structure
177 flag electrode
179 column electric feed 181 row electric feed

1. An electromodulating display comprising
(1) a nonconductive polymeric unitary substrate containing a plurality of patterned grooves containing an electrically-conductive material so as to form an electrical network having a switchable electric field orientation and
(2) a switch for switching the electric field orientation; and
(3) a medium that is optically shifted in response to the switching of the electric field orientation.

2. The display of claim 1 wherein the plurality of patterned grooves further contains a dielectric material.

3. The display of claim 1 wherein the plurality of patterned grooves further contains varying fillers.

4. The display of claim 3 wherein said plurality of patterned grooves comprise at least one first region wherein the grooves in the first region comprise at least one different filling material composition than the grooves outside of the first region.

5. The display of claim 1 wherein a plurality of patterned grooves form variable cross-sections.

6. The display of claim 1 wherein at least one of the patterned grooves transitions in depth to form a termination point at or near the surface of said layer of non-conducting polymer material.

7. The display of claim 1 wherein a plurality of patterned grooves form at least one electrode selected from the group consisting of a busbar, gate electrode, helper electrode and flag electrode.

8. The display of claim 1 wherein said electromodulating display further comprises a microcell for containing said medium that is optically shifted in response to the switching of the electric field orientation.

9. The display of claim 1 wherein said medium comprises at least one electromodulating function selected from the group of electrophoretic, electrowetting, liquid crystal, electrochromic, and an optical switch and shutter.

10. The display of claim 1 wherein said display further comprises a layer of hydrophobic material.

11. The electromodulating display of claim 1 further comprises an array of sealed cells.

12. The electromodulating display of claim 1 wherein said plurality of patterned grooves containing an electrically-conductive material is opaque.

13. The electromodulating display of claim 1 wherein said electrically-conductive material comprises at least one material selected from the group consisting of silver, gold, aluminum, zinc, and copper.

14. The electromodulating display of claim 1 wherein said electrically-conductive material comprises a conductive metallic material.

15. The electromodulating display of claim 1 further comprising bias connecting two or more electrical features.

16. The electromodulating display of claim 1 capable of being bent to a diameter of 50 cm or less.

17. The electromodulating display of claim 1 wherein said plurality of patterned grooves containing an electrically-conductive material has a conductivity of less than 5000 ohms/sq.

18. The electromodulating display of claim 1 comprising a plurality of patterned grooves containing an electrically-conductive material and further comprising an electrical insulating material.

19. The electromodulating display of claim 1 containing a plurality of patterned grooves containing two or more electrically-conductive materials separated by at least one electrical insulating material.

20. The electromodulating display of claim 19 wherein said two or more electrically-conductive materials separated by an electrical insulating material form an electrical cross-over.

21. A method of making an electromodulating display containing a nonconductive polymeric unitary substrate containing a plurality of patterned grooves containing an electrically-conductive material comprising
(a) forming a plurality of patterned grooves integrally in a polymeric unitary substrate;
(b) introducing a first electrically conductive material into the groove partly filling the groove;
(c) applying a dielectric on top of all or part of the conductive material in the groove;
(d) patterning a second conductive layer that forms cross-over regions with the first electrical conductive material and dielectric;
(e) filling said microcells with a medium that is optically shiftable in response to the switching of the electric field between conductive materials;
(f) sealing said medium with a polymeric layer or layers; and
(g) attaching a voltage/current source that switches voltages to shift the medium in response to the voltage.

22. The electromodulating display of claim 21 further comprises a surface patterning of electrode features.
